(19) United States
(12) Patent Application Publication
(10) Pub. No.: US 2026/0317209 A1
(43) Pub. Date: Oct. 15, 2026

(54) METHOD FOR OPERATING DEIONIZED WATER PRODUCTION SYSTEM AND DEIONIZED WATER PRODUCTION SYSTEM

(71) Applicant: ORGANO CORPORATION, Tokyo (JP)

(72) Inventors: Keisuke SASAKI, Tokyo (JP); Mayu ABE, Tokyo (JP); Atsushi NAGAYAMA, Tokyo (JP); Shogo KUSHIDA, Tokyo (JP); Hiroki NARITA, Tokyo (JP); Fumio SUDO, Tokyo (JP)

(73) Assignee: ORGANO CORPORATION, Tokyo (JP)

(21) Appl. No.: 19/484,715

(22) PCT Filed: Apr. 15, 2024
(86) PCT No.: PCT/JP2024/015000

§ 371 Date: Nov. 14, 2025

(30) Foreign Application Priority Data
May 17, 2023 (JP) 2023-081609
Jul. 21, 2023 (JP) 2023-119342

(51) Int. Cl. C02F 1/469; C02F 1/26

(52) U.S. Cl. CPC C02F 1/4695; C02F 1/265; C02F 2201/4617; C02F 2209/001; C02F 2209/003; C02F 2209/05; C02F 2209/40; C02F 2209/44

(57) ABSTRACT

A water intake mode passes water through a demineralization chamber of an electrodeionization device to obtain treated water when the electrodeionization device is not energized. A water intake and regeneration mode that, while the electrodeionization device is energized, is operated alternately in the water intake mode and passes water through the demineralization chamber to obtain treated water and water is passed through a concentration chamber and/or an electrode chamber of the electrodeionization device. Water quality of the treated water is measured, and a preset first threshold value is provided for the measured value of the water quality to prevent the water quality from deteriorating below a predetermined value. The water intake and regeneration mode and the water intake mode are switched based on the measured value using the first threshold value as a base point.

### TECHNICAL FIELD

The present invention relates to a method for operating a deionized water production system having an electrodeionized water production device and to a deionized water production system.

### BACKGROUND OF ART

Deionized water production systems are known in which water to be treated is passed through an ion exchanger such as an ion exchange resin to perform deionization through an ion exchange reaction. Such systems generally include a device having an ion exchanger and produce deionized water (e.g., pure water) by utilizing an ion exchange reaction caused by the ion exchanger. However, in a device having an ion exchanger, the ion exchange groups of the ion exchanger become saturated as the water to be treated passes through the device, causing a decrease in the deionization performance. As a result, a process must be carried out to restore the deionization performance of the ion exchanger (hereinafter referred to as “regeneration”).

Known methods for regenerating an ion exchanger include periodically replacing the ion exchanger with new ion exchanger, periodically regenerating the ion exchanger using a chemical such as an acid or an alkali, and continuously regenerating the ion exchanger using an electrodeionization device (also called an EDI device).

In the method of periodically replacing the ion exchanger, deionized water cannot be produced during the replacement operation. Therefore, this method has the problem that deionized water cannot be produced continuously. In addition, when water to be treated is passed through the ion exchanger at a high flow rate to produce deionized water, the deionization performance decreases at a faster rate, and the ion exchanger must be replaced relatively frequently. Therefore, this method is not suitable for producing deionized water from water to be treated that is processed at a high flow rate. Furthermore, the ion exchanger used is disposed of after replacement, resulting in an increase in waste.

The method of regenerating the ion exchanger using chemicals requires time and effort to procure chemicals such as acids and alkalis. In addition, the method has the problem that deionized water cannot be produced continuously because deionized water cannot be produced during the regeneration of the ion exchanger.

To continuously produce deionized water in a method in which an ion exchanger is periodically replaced or a system in which a chemical is used to regenerate an ion exchanger, a method can be considered in which, for example, a currently used ion exchanger and a spare ion exchanger are prepared and used by alternately switching between them. However, such a method requires the preparation of facilities for filling the ion exchanger and for injecting the necessary chemicals for regeneration.

An EDI device is configured such that a plurality of anion exchange membranes and cation exchange membranes are arranged between electrodes (anodes and cathodes) to form electrode chambers, concentration chambers, and demineralization chambers, these demineralization chambers being filled with ion exchangers (anion exchangers and cation exchangers). Water to be treated is supplied to the demineralization chambers, and the water (e.g., the water to be treated, deionized water) is supplied to the electrode chambers and the concentration chambers. The EDI device maintains deionization performance by applying a voltage between the electrodes to cause an electric current to flow that causes a water dissociation reaction that generates hydrogen ions (H⁺) and hydroxide ions (OH⁻), and these ions are then exchanged with ions attached to the ion exchanger in the demineralization chambers. Therefore, the use of an EDI device enables continuous production of deionized water and regeneration of the ion exchanger. Such an EDI device is described in, for example, Patent Document 1.

### PRIOR ART DOCUMENTS

### Patent Documents

Patent Document 1: WO2018/117035A1

### SUMMARY OF THE INVENTION

### Problem to be Solved by the Invention

In order to prevent deterioration of the quality of deionized water (treated water) due to a decrease in deionization performance, an EDI device is usually kept energized at all times during operation. Therefore, a deionized water production system equipped with an EDI device has the problem of high power consumption. During operation, water to be treated is supplied to the demineralization chamber, and water is also supplied to the concentration chamber and the electrode chamber. As a result, deionized water is produced in the demineralization chamber, while concentrated water containing ions that have migrated from the demineralization chamber is discharged from the concentration chamber, and electrode water is discharged from the electrode chamber. Therefore, the problem therefore exists that the EDI device entails a large amount of wastewater.

The present invention has been realized to solve the problems inherent in the background art as described above, and an object of the present invention is to provide a method for operating a deionized water production system and a deionized water production system that can reduce both power consumption and the amount of wastewater of an electrodeionization device while also suppressing the deterioration of the water quality of treated water.

### Means for Solving the Problem

In order to achieve the above object, a method of operating a deionized water production system according to the present invention is a method of operating a deionized water production system that produces deionized water from water to be treated using an electrodeionization device, comprising:
providing a water intake mode in which the water to be treated is passed through a demineralization chamber of the electrodeionization device to obtain treated water when the electrodeionization device is not energized, and
a water intake and regeneration mode that is operated alternately with the water intake mode and in which the water to be treated is passed through the demineralization chamber to obtain the treated water and water is passed through at least one of a concentration chamber and an electrode chamber of the electrodeionization device while the electrodeionization device is energized;
measuring water quality of the treated water; and
providing a first threshold value, which is preset for the measured value of the water quality of the treated water, to prevent the water quality of the treated water from deteriorating below a predetermined value, and switching between the water intake and regeneration mode and the water intake mode based on the measured value using the first threshold value as a base point.

Alternatively, a method of operating a deionized water production system according to the present invention is a method of operating a deionized water production system that produces deionized water from water to be treated using a plurality of electrodeionization devices that have water flow paths connected in parallel or in series, comprising:
providing a water intake and regeneration mode in which the water to be treated is passed through the demineralization chamber to obtain the treated water and water is passed through at least one of a concentration chamber and an electrode chamber of the electrodeionization device while the electrodeionization device is energized with a first current, and a water intake mode in which the water to be treated is passed through a demineralization chamber of the electrodeionization device to obtain treated water in an energized state in which the electrodeionization device is energized with a second current lower than the first current or in an unenergized state in which the electrodeionization device is not energized;
operating each of at least two electrodeionization devices among the plurality of electrodeionization devices alternately in the water intake mode and the water intake and regeneration mode; and
performing, at least two different start and end timings, the operation of the water intake and regeneration mode in the plurality of electrodeionization devices that are operated alternately in the water intake mode and the water intake and regeneration mode.

Alternatively, a method of operating a deionized water production system according to the present invention is a method of operating a deionized water production system that produces deionized water from water to be treated using a plurality of electrodeionization devices that have water flow paths connected in parallel or in series, comprising:
providing a water intake and regeneration mode in which the water to be treated is passed through the demineralization chamber to obtain the treated water and water is passed through at least one of a concentration chamber and an electrode chamber of the electrodeionization device while the electrodeionization device is energized with a first current, and
a water intake mode in which the water to be treated is passed through a demineralization chamber of the electrodeionization device to obtain treated water in an energized state in which the electrodeionization device is energized with a second current lower than the first current or in an unenergized state in which the electrodeionization device is not energized;
operating at least one first electrodeionization device among the plurality of electrodeionization devices alternately in the water intake mode and the water intake and regeneration mode; and
operating a second electrodeionization device that is different from the first electrodeionization device in the water intake and regeneration mode.

On the other hand, a deionized water production system according to the present invention includes:
an electrodeionization device that produces deionized water from water to be treated;
a power supply device that applies a required DC voltage to the electrodeionization device;
a water quality measurement instrument that measures water quality of treated water obtained by passing the water to be treated through a demineralization chamber of the electrodeionization device; and
a control device that provides a water intake mode in which the water to be treated is passed through the demineralization chamber of the electrodeionization device to the obtain treated water when the electrodeionization device is not energized, and a water intake and regeneration mode that is operated alternately with the water intake mode and in which the water to be treated is passed through the demineralization chamber to obtain the treated water and water is passed through at least one of a concentration chamber and an electrode chamber of the electrodeionization device while the electrodeionization device is energized, wherein the control device has a first threshold value that is preset for the measured value of the water quality of the treated water to prevent the water quality of the treated water from deteriorating below a predetermined value and switches between the water intake and regeneration mode and the water intake mode based on the measured value using the first threshold value as a base point.

Alternatively, a deionized water production system according to the present invention includes:
a plurality of electrodeionization devices that produce deionized water from water to be treated and that have water flow paths connected in series;
a power supply device that applies a required DC voltage to the electrodeionization device; and
a control device that provides a water intake and regeneration mode in which the water to be treated is passed through the demineralization chamber to obtain the treated water and water is passed through at least one of a concentration chamber and an electrode chamber of the electrodeionization device while the electrodeionization device is energized with a first current, and a water intake mode in which the water to be treated is passed through a demineralization chamber of the electrodeionization device to obtain treated water in an energized state in which the electrodeionization device is energized with a second current lower than the first current or in an unenergized state in which the electrodeionization device is not energized, wherein the control device alternately operates each of at least two electrodeionization devices among the plurality of electrodeionization devices in the water intake mode and the water intake and regeneration mode,
wherein the control device performs, at least two different start and end timings, an operation according to the water intake and regeneration mode in the plurality of electrodeionization devices that are operated alternately in the water intake mode and the water intake and regeneration mode.

Alternatively, a deionized water production system according to the present invention includes:
a plurality of electrodeionization devices that produce deionized water from water to be treated and that have water flow paths connected in series;
a power supply device that applies a required DC voltage to the electrodeionization device; and
a control device that provides a water intake and regeneration mode in which the water to be treated is passed through the demineralization chamber to obtain the treated water and water is passed through at least one of a concentration chamber and an electrode chamber of the electrodeionization device while the electrodeionization device is energized with a first current, and a water intake mode in which the water to be treated is passed through a demineralization chamber of the electrodeionization device to obtain treated water in an energized state in which the electrodeionization device is energized with a second current lower than the first current or in an unenergized state in which the electrodeionization device is not energized, wherein the control device operates at least one first electrodeionization device among the plurality of electrodeionization devices alternately in the water intake mode and the water intake and regeneration mode,
wherein the control device operates a second electrodeionization device that is different from the first electrodeionization device in the water intake and regeneration mode.

Alternatively, a deionized water production system according to the present invention includes:
a plurality of electrodeionization devices that produce deionized water from water to be treated and that have water flow paths connected in parallel;
a power supply device that applies a required DC voltage to the electrodeionization device;
a control device that provides a water intake and regeneration mode in which the water to be treated is passed through the demineralization chamber to obtain the treated water and water is passed through at least one of a concentration chamber and an electrode chamber of the electrodeionization device while the electrodeionization device is energized with a first current, and a water intake mode in which the water to be treated is passed through a demineralization chamber of the electrodeionization device to obtain treated water in an energized state in which the electrodeionization device is energized with a second current lower than the first current or in an unenergized state in which the electrodeionization device is not energized, wherein the control device alternately operates each of at least two electrodeionization devices among the plurality of electrodeionization devices in the water intake mode and the water intake and regeneration mode; and
a confluence section that combines the treated water from the plurality of electrodeionization devices,
wherein the control device performs, at least two different start and end timings, an operation according to the water intake and regeneration mode in the plurality of electrodeionization devices that are operated alternately in the water intake mode and the water intake and regeneration mode.

Alternatively, a deionized water production system according to the present invention includes:
a plurality of electrodeionization devices that produce deionized water from water to be treated and that have water flow paths connected in parallel;
a power supply device that applies a required DC voltage to the electrodeionization device;
a control device that provides a water intake and regeneration mode in which the water to be treated is passed through the demineralization chamber to obtain the treated water and water is passed through at least one of a concentration chamber and an electrode chamber of the electrodeionization device while the electrodeionization device is energized with a first current, and a water intake mode in which the water to be treated is passed through a demineralization chamber of the electrodeionization device to obtain treated water in an energized state in which the electrodeionization device is energized with a second current lower than the first current or in an unenergized state in which the electrodeionization device is not energized, wherein the control device alternately operates at least one first electrodeionization device among the plurality of electrodeionization devices in the water intake mode and the water intake and regeneration mode; and
a confluence section that combines the treated water from the plurality of electrodeionization devices,
wherein the control device operates a second electrodeionization device that is different from the first electrodeionization device in the water intake and regeneration mode.

### Advantageous Effects of the Invention

According to the present invention, power consumption and the amount of wastewater of an electrodeionization device can be reduced while suppressing deterioration of the water quality of treated water.

### BRIEF DESCRIPTION OF THE DRAWINGS

FIG. 1 is a block diagram showing an example of the configuration of a deionized water production system according to a first embodiment;

FIG. 2 is a schematic diagram showing an example of the schematic configuration of the electrodeionization device shown in FIG. 1;

FIG. 3 is a schematic diagram showing another example of the schematic configuration of the electrodeionization device shown in FIG. 1;

FIG. 4 is a schematic diagram showing another example of the schematic configuration of the electrodeionization device shown in FIG. 1;

FIG. 5 is a block diagram showing an example of the configuration of a deionized water production system according to a second embodiment;

FIG. 6A is a block diagram showing an example of the configuration of the confluence section shown in FIG. 5.

FIG. 6B is a block diagram showing an example of the configuration of the confluence section shown in FIG. 5.

FIG. 6C is a block diagram showing an example of the configuration of the confluence section shown in FIG. 5.

FIG. 7 is a block diagram showing an example of a modification of a deionized water production system according to a second embodiment;

FIG. 8 is a block diagram showing another example of a modification of the deionized water production system according to the second embodiment;

FIG. 9 is a block diagram showing an example of the configuration of a deionized water production system according to a third embodiment;

FIG. 10 is a block diagram showing an example of a modification of the deionized water production system according to the third embodiment;

FIG. 11 is a graph showing changes in current efficiency and the conductivity of treated water with respect to the regeneration time of an ion exchanger;

FIG. 12 is a schematic diagram showing operation modes of a deionized water production system according to a first example;

FIG. 13 is a graph showing changes in the conductivity of water to be treated and the conductivity of treated water according to the first example;

FIG. 14 is a graph showing changes in the demineralization rate of treated water and the power consumption of an EDI device according to the first example;

FIG. 15 is a schematic diagram showing operation modes of a deionized water production system according to a second example;

FIG. 16 is a graph showing changes in the conductivity of water to be treated and the resistivity of treated water according to the second example;

FIG. 17 is a graph showing changes in the demineralization rate of treated water and the power consumption of an EDI device according to the second example;

FIG. 18 is a graph showing changes in the conductivity of water to be treated and the conductivity of treated water according to a first comparative example;

FIG. 19 is a graph showing changes in the demineralization rate of treated water and the power consumption of an EDI device according to the first comparative example;

FIG. 20 is a graph showing changes in the conductivity of water to be treated and the conductivity of treated water according to a second comparative example;

FIG. 21 is a graph showing changes in the demineralization rate of treated water and the power consumption of an EDI device according to the second comparative example;

FIG. 22 is a graph showing changes in the conductivity of water to be treated and the conductivity of treated water according to a third comparative example;

FIG. 23 is a graph showing changes in the demineralization rate of treated water and the power consumption of an EDI device according to the third comparative example;

FIG. 24 is a block diagram showing an example of a modification of the operation of a deionized water production system;

FIG. 25 is a block diagram showing another example of a modification of the operation of a deionized water production system;

FIG. 26 is a graph showing an example of the transition of operation modes of an EDI device according to a fourth example;

FIG. 27 is a graph showing changes in the conductivity of the water to be treated and the conductivity of the treated water according to the fourth example;

FIG. 28 is a graph showing changes in the demineralization rate of treated water and the power consumption of an EDI device according to the fourth example;

FIG. 29 is a graph showing an example of the transition of operation modes of an EDI device according to a fourth comparative example;

FIG. 30 is a graph showing changes in the conductivity of water to be treated and the conductivity of treated water according to the fourth comparative example;

FIG. 31 is a graph showing changes in the demineralization rate of treated water and the power consumption of an EDI device according to the fourth comparative example; and

FIG. 32 is a graph showing an example of the transition of changes in the conductivity of water to be treated and the resistivity of treated water of each EDI device according to a fifth example.

### DESCRIPTION OF THE EMBODIMENTS

The invention will next be described using the drawings.

### First Embodiment

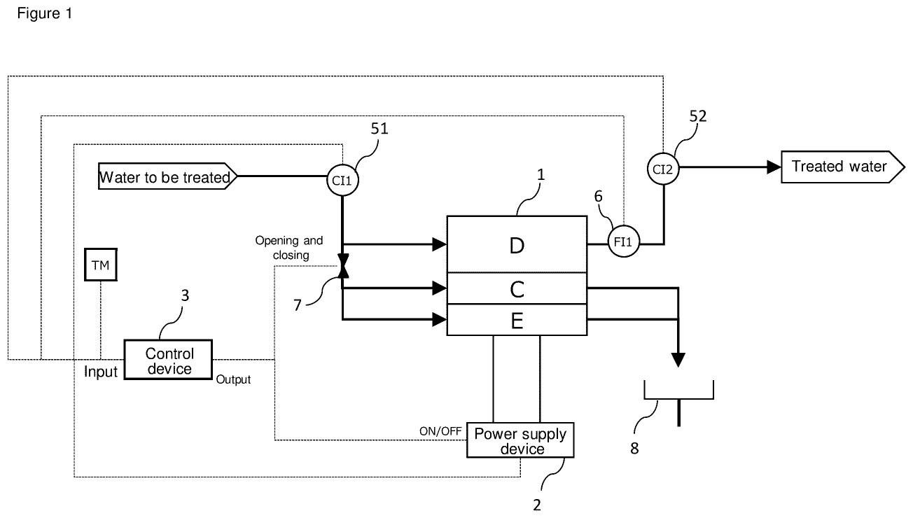

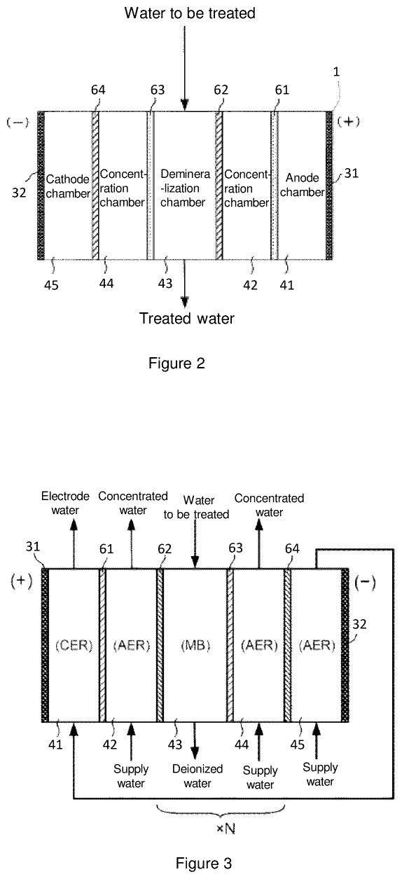

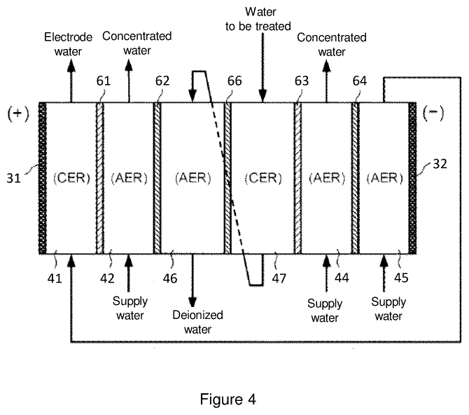

FIG. 1 is a block diagram showing an example of the configuration of a deionized water production system according to the present invention. FIG. 2 is a schematic diagram showing an example of the configuration of the electrodeionization device shown in FIG. 1. FIGS. 3 and 4 are schematic diagrams showing other examples of the configuration of the electrodeionization device shown in FIG. 1. FIGS. 2 to 4 show the configuration disclosed in the above-mentioned Patent Document 1.

As shown in FIG. 1, the deionized water production system of the first embodiment includes electrodeionization device (EDI device) 1 that produces deionized water from water to be treated, power supply device 2 that applies to EDI device 1 a required DC voltage necessary for maintaining the performance of deionization, and control device 3 that controls the operation of the entire deionized water production system. The water to be treated is sent to a demineralization chamber (D) of EDI device 1 using, for example, a pump (not shown), and the demineralization chamber (D) produces treated water (deionized water).

The water to be treated and the treated water are measured for their respective water quality using well-known water quality measurement instruments 5 (51 and 52). The water quality of the water to be treated does not have to be measured. Water quality measurement instruments 5 may be, for example, conductivity meters that measure the conductivity of each of the water to be treated and the treated water, resistivity meters that measure the resistivity of each of the water to be treated and the treated water, or concentration meters that measure the ion concentration in each of the water to be treated and the treated water. The deionized water production system may also be equipped with a well-known flow meter (integrating flow meter) 5 that measures the discharge amount (production amount) of the treated water from the demineralization chamber (D) of EDI device 1.

Control device 3 is connected to water quality measurement instruments 5 and flow meter 6 via known communication means, and measurement data on the water quality of the water to be treated and the treated water as well as data on the production amount of the treated water are transmitted. Furthermore, a pump (not shown) and valve 7 control the supply and shut-off of the water to be treated to the concentration chamber (C) and the electrode chamber (E) of EDI device 1. The concentrated water discharged from the concentration chamber (C) and the electrode water discharged from the electrode chamber are each discharged into drain tank 8.

FIG. 1 shows an example in which the water to be treated is supplied to the concentration chamber (C) and the electrode chamber (E) of EDI device 1. The treated water may be supplied to the concentration chamber (C) and the electrode chamber (E), or water may be supplied to the concentration chamber (C) and the electrode chamber (E) from a system that is separate from the deionized water production system shown in FIG. 1. In a configuration in which water is supplied to the concentration chamber (C) and the electrode chamber (E) from a system that is separate from the deionized water production system shown in FIG. 1, EDI device 1 can be operated without changing the flow rate of the supply of water to be treated to the demineralization chamber (D).

Control device 3 is connected to power supply device 2, the pump, and valve 7 via known communication means and is capable of controlling the operations of power supply device 2, the pump, and valve 7. Control device 3 effects on/off control of power supply device 2 and also uses the pump and valve 7 to control the supply and shut-off of the water to be treated to the demineralization chamber (D) of EDI device 1 as well as to control the supply and shut-off of the water to be treated to the concentration chamber (C) and electrode chamber (E) of EDI device 1. Control device 3 also operates EDI device 1 in two operation modes, a water intake mode and a water intake and regeneration mode, to be described below. The communication means between control device 3 and each of power supply device 2, the pump, valve 7, water quality measurement instrument 5, and flow meter 6 may be any well-known wired communication means or wireless communication means, and any well-known communication standard may be used.

Control device 3 can be realized by, for example, a well-known Programmable Logic Controller (PLC). Control device 3 may be realized by a known information processing device (computer) including a Central Processing Unit (CPU), a storage device, an I/O interface, a communication device, and the like. Control device 3 realizes the operation method of the deionized water production system of the present invention by having a processor in the PLC or information processing device execute processing according to a program stored in advance in the storage device.

Although not shown in FIG. 1, to obtain deionized water with a sufficiently reduced impurity concentration, the deionized water production system of the present invention may be equipped with a reverse osmosis membrane device that includes a well-known reverse osmosis membrane (RO membrane) in the stage preceding EDI device 1. The deionized water production system may include multiple stages (e.g., two stages) of reverse osmosis membrane devices that are connected in series. When a two-stage reverse osmosis membrane device is provided, raw water stored in a storage tank or the like is passed through the first-stage reverse osmosis membrane device, the permeated water thereof is passed through the second-stage reverse osmosis membrane device, and the permeated water from the second-stage reverse osmosis membrane device is sent to the demineralization chamber of EDI device 1 as the water to be treated. The reverse osmosis membrane device may be configured to include a general reverse osmosis membrane used, for example, for producing pure water.

As shown in FIG. 2, EDI device 1 includes a configuration in which multiple pairs of cation exchange membranes and anion exchange membranes (two pairs in FIG. 2) are arranged between two electrodes (anode 31 and cathode 32) to form electrode chambers 41 and 45, concentration chambers 42 and 44, and demineralization chamber 43. Electrode chamber (anode chamber) 41 is formed by anode 31 and cation exchange membrane 61, and electrode chamber (cathode chamber) 45 is formed by cathode 32 and anion exchange membrane 64. Demineralization chamber 43 is formed by anion exchange membrane 62 and cation exchange membrane 63, and two concentration chambers 42 and 44 are formed with demineralization chamber 43 between them. Concentration chamber 42 on the anode-31 side is formed by cation exchange membrane 61 and anion exchange membrane 62, and concentration chamber 44 on the cathode-32 side is formed by cation exchange membrane 63 and anion exchange membrane 64. Demineralization chamber 43 is filled with an ion exchanger that is a mixture of a cation exchanger and an anion exchanger. Electrode chambers 41 and 45 and concentration chambers 42 and 44 may be filled with ion exchangers as appropriate.

As shown in FIG. 3, EDI device 1 may also include a configuration in which multiple basic components (cell sets) consisting of concentration chamber 42, demineralization chamber 43, and concentration chamber 44 shown in FIG. 2 are arranged side by side between anode 31 and cathode 32. In this case, adjacent concentration chambers can be shared between adjacent cell sets. FIG. 3 shows an example of a configuration in which N (N being an integer of 1 or more) cell sets are arranged between anode 31 and cathode 32. In EDI device 1 shown in FIG. 3, electrode chamber (anode chamber) 41 is filled with a cation exchanger (CER), concentration chambers 42 and 44 and electrode chamber (cathode chamber) 45 are filled with an anion exchanger (AER), and demineralization chamber 43 is filled with an ion exchanger (MB) that is a mixture of a cation exchanger and an anion exchanger. Furthermore, EDI device 1 shown in FIG. 3 is configured such that water is not supplied to electrode chamber (anode chamber) 41 from the outside, but outlet water of electrode chamber (cathode chamber) 45 is supplied to electrode chamber (anode chamber) 41.

As shown in FIG. 4, EDI device 1 may also include a configuration in which two demineralization chambers 46 and 47 are formed by disposing intermediate ion exchange membrane 66 between two concentration chambers 42 and 44. In EDI device 1 shown in FIG. 4, demineralization chamber 46 is filled with an anion exchanger (AER), and demineralization chamber 47 is filled with a cation exchanger (CER). The water to be treated is passed through demineralization chamber 47 and then through demineralization chamber 46. The two demineralization chambers 46 and 47 do not need to be filled with the same amount of ion exchanger. For example, one demineralization chamber may be filled with a cation exchanger and an anion exchanger, and the other demineralization chamber may be filled with only a cation exchanger. Alternatively, one demineralization chamber may be filled with a cation exchanger and an anion exchanger, and the other demineralization chamber may be filled with only an anion exchanger.

As mentioned above, EDI device 1 may also be configured such that the ion exchanger (anion exchange membrane 64 or cation exchange membrane 61) that separates an electrode chamber from a concentration chamber is eliminated, one chamber thus serving as both an electrode chamber and a concentration chamber. In this case, because the electrode chamber and the concentration chamber have the same flow path, the operation method is to pass water through only one of them.

In this configuration, the inventors have found that when regenerating an ion exchanger in an EDI device, the efficiency of power utilization for regeneration is improved when the proportion of the salt form of the ion exchanger is high. Furthermore, the inventors have found that when EDI device 1 is not energized, deionized water is produced by passing the water to be treated only through the demineralization chamber without allowing water to flow through the concentration chamber and the electrode chamber of EDI device 1, whereby deionized water of the same quality is produced as when EDI device 1 is continuously operated while energized while reducing power consumption and the amount of wastewater.

In the first embodiment, EDI device 1 has two operation modes: a water intake mode in which the water to be treated is passed through the demineralization chamber (D) to obtain treated water when EDI device 1 is not energized; and a water intake and regeneration mode in which, while EDI device 1 is energized, the water to be treated is passed through the demineralization chamber (D) to obtain the treated water and water is passed through at least one of the concentration chamber (C) and the electrode chamber (E). EDI device 1 is operated alternately in the water intake mode and the water intake and regeneration mode to reduce the amount of wastewater from EDI device 1 while reducing the power consumption of EDI device 1. In the water intake mode, water is basically not supplied to the concentration chamber (C) and the electrode chamber (E) (no water flow).

Furthermore, there is no reason why water should not be passed through the concentration chamber (C) and the electrode chamber (E) of EDI device 1 when EDI device 1 is not energized, and water can also be passed through the concentration chamber (C) and the electrode chamber (E) in the water intake mode. The amount of water passing through the concentration chamber (C) and the electrode chamber (E) in the water intake mode may be any amount so long as the amount of wastewater discharged from EDI device 1 in the water intake mode is less than the amount of wastewater discharged from EDI device 1 in the water intake and regeneration mode. The amount of water passing through the concentration chamber (C) and the electrode chamber (E) in the water intake mode is preferably ½ or less of the amount of water passed in the water intake and regeneration mode in order to achieve the object of the present invention of reducing the amount of wastewater discharged from EDI device 1. More preferably, the amount of water passing through the concentration chamber (C) and the electrode chamber (E) in the water intake mode is ⅕ or less of the amount of the water passed in the water intake and regeneration mode.

When water is passed through the concentration chamber (C) and the electrode chamber (E) in the water intake mode, water may be passed through at least one of the concentration chamber (C) and the electrode chamber (E). The term “no water flow,” in which water is not passed through the concentration chamber (C) and the electrode chamber (E), is not limited to the state in which water is not supplied to the concentration chamber (C) and the electrode chamber (E) at all, but also includes a state in which a limited amount of water is supplied.

Furthermore, the term “non-energized” used here refers to a state in which the water dissociation reaction does not proceed within EDI device 1 and includes applying a weak voltage between the electrodes for purposes such as preventing ion diffusion from the concentration chamber (C) to the demineralization chamber (D). For example, because the theoretical voltage required for water dissociation is 0.83 V, this “non-energized” state includes applying a voltage of 0.83 V or less per demineralization chamber (D).

EDI device 1 can also be energized in the water intake mode. However, a current that energizes EDI device 1 in the water sampling mode shall be a current (second current) that is lower than the current (first current) passed through EDI device 1 during normal operation (the water intake and regeneration mode). When EDI device 1 is energized in the water intake mode, the second current is preferably equal to or less than ½ of the first current to achieve the object of the present invention of reducing the power consumption of EDI device 1. More preferably, the second current is equal to or less than ⅕ of the first current.

The water intake mode described above has the advantage that no water or only a small amount of water is discharged from the concentration chamber (C) and the electrode chamber (E) of EDI device 1. However, since the deionization performance of EDI device 1 decreases over time, the water quality of the treated water gradually deteriorates. On the other hand, the water intake and regeneration mode has the advantage that the deionization performance of EDI device 1 is regenerated over time, whereby the water quality of the treated water is gradually improved. However, a large amount of wastewater is discharged from the concentration chamber (C) and the electrode chamber (E) of EDI device 1. Therefore, if EDI device 1 is operated alternately in the water intake mode and the water intake and regeneration mode, the water quality of the treated water fluctuates relatively greatly.

Therefore, in the first embodiment, to reduce the amount of wastewater discharged from EDI device 1 while suppressing deterioration of the water quality of the treated water, the water quality of the treated water is measured, and EDI device 1 is operated by alternately switching between the above water intake mode and the water intake and regeneration mode based on the measured values. Specifically, the conductivity, resistivity, or concentration that indicates the water quality of the treated water is measured, a threshold value (first threshold value) is set for switching from the water intake mode to the water intake and regeneration mode, and a threshold value (second threshold value) is set for switching from the water intake and regeneration mode to the water intake mode. The first threshold value is provided to prevent the water quality of the treated water from deteriorating below a predetermined value. The second threshold value is provided to reduce both the power consumption of EDI device 1 and the amount of wastewater discharged from EDI device 1. Control device 3 monitors changes in the measured value of the water quality of the treated water as measured by water quality measurement instruments 5 and switches between the water intake mode and the water intake and regeneration mode when the measured values reach these threshold values.

Threshold values may be set by taking into consideration changes in the water quality of the treated water and the amount of wastewater discharged obtained by actually operating the deionized water production system shown in FIG. 1 based on the desired or required quality of the treated water of the deionized water production system and the amount of wastewater discharged from EDI device 1.

The threshold value may be only the first threshold value mentioned above to prevent the water quality of the treated water from deteriorating below a predetermined value. In this case, control device 3 may switch to the water intake and regeneration mode when the measured value of the water quality of the treated water reaches the first threshold value in the water intake mode. The water intake and regeneration mode can, for example, be operated for a preset time and then switched back to the water intake mode. The operating time of the water intake and regeneration mode should be set by taking into consideration the changes in the quality of the treated water obtained by actually operating the deionized water production system shown in FIG. 1 based on the desired or required quality of the treated water of the deionized water production system.

In an operation method that uses only the first threshold value, the operating time of the water intake and regeneration mode may, for example, be set longer than the required operating time in order to respond to fluctuations in the water quality of the water to be treated. Therefore, the operation method that uses only the first threshold value may increase the power consumption of EDI device 1 and the amount of wastewater discharged from EDI device 1 compared to the operation method that uses the first and second threshold values to switch between the water intake mode and the water intake and regeneration mode. However, by switching from the water intake mode to the water intake and regeneration mode using the first threshold value as a base point, the water quality of the treated water does not deteriorate below a predetermined water quality that corresponds to the first threshold value. In addition, including the above water intake mode in the operation of the deionized water production system enables a reduction of the power consumption of EDI device 1 and the amount of wastewater discharged from EDI device 1 compared to a conventional deionized water production system.

If the operation mode is here switched when the measured value of the water quality of the treated water reaches the threshold value, the measured value of the water quality is expected to continue in the previous state (rising or falling) for a certain period of time thereafter (from several minutes to several tens of minutes). Therefore, the threshold value should be appropriately set to a value less than or greater than the predetermined value that corresponds to the desired or required water quality of the treated water of the deionized water production system so that the water quality of the treated water does not deteriorate more than the predetermined value. Alternatively, the threshold value should be appropriately set to a value less than or greater than a predetermined value that corresponds to the desired or required amount of wastewater of the deionized water production system so that the amount of wastewater does not exceed the predetermined value. The threshold value may be a fixed value during operation of the deionized water production system, or may be changed depending on, for example, the measured value of the water quality of the treated water, the power consumption, or the amount of wastewater of the deionized water production system.

In this way, a first threshold value is provided that is preset for the measured value of the water quality of the treated water to prevent the water quality of the treated water from deteriorating below a predetermined value, the water quality of the treated water is measured, and control device 3 switches between the water intake and regeneration mode and the water intake mode based on the measured value using the first threshold value as a base point. This allows the deterioration of the water quality of the treated water to be suppressed even if the water quality of the treated water fluctuates. Furthermore, including the above-described water collection mode in the operation of the deionized water production system enables a reduction of the power consumption of EDI device 1 and the amount of wastewater discharged from EDI device 1 compared to conventional deionized water production systems. The power consumption and the amount of wastewater of EDI device 1 can thus be reduced while suppressing deterioration of the water quality of the treated water. In addition, compared to an operation method that uses only the first threshold value, providing a second threshold value in addition to the first threshold value and using this second threshold value as a base point to switch from the water intake mode to the water intake and regeneration mode can reduce the power consumption and the amount of wastewater of EDI device 1 while suppressing deterioration of the water quality of the treated water.

### Second Embodiment

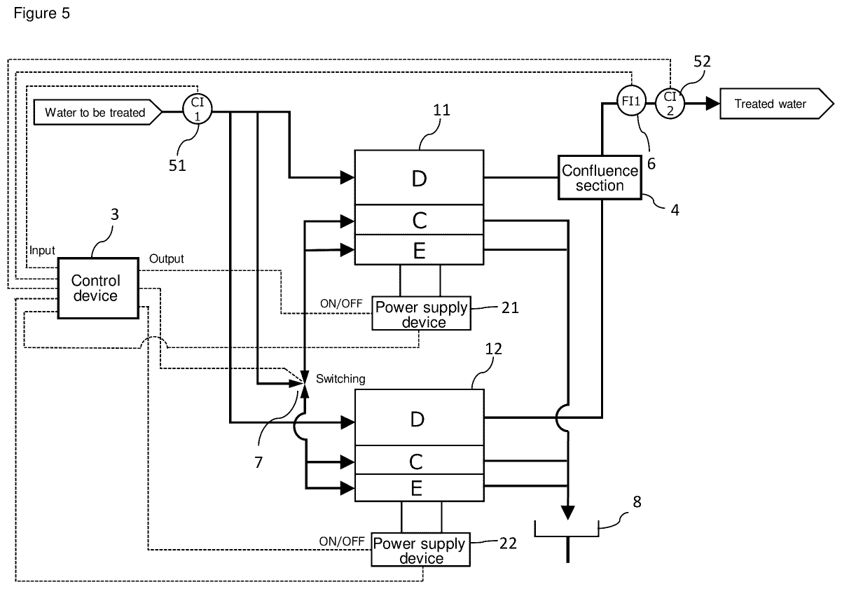

FIG. 5 is a block diagram showing an example of the configuration of a deionized water production system according to a second embodiment.

As shown in FIG. 5, the deionized water production system of the second embodiment comprises EDI devices 11 and 12 that produce deionized water from water to be treated and that have water flow paths connected in parallel, power supply devices 21 and 22 that apply to EDI devices 11 and 12 a required DC voltage necessary for maintaining deionization performance, control device 3 that controls the operation of the entire deionized water production system, and confluence section 4 that combines the treated water from EDI devices 11 and 12. The water to be treated is sent to the demineralization chambers (D) of each of EDI devices 11 and 12 using, for example, a pump (not shown), and each demineralization chamber (D) produces the treated water (deionized water).

FIG. 5 shows an example of the configuration of a deionized water production system that has two EDI devices 11 and 12 and water flow paths connected in parallel. The deionized water production system of the second embodiment may be configured with three or more EDI devices 1 with water flow paths connected in parallel. In the following explanation, the plurality of EDI devices will be referred to collectively as EDI device 1 and the plurality of power supply devices will be referred to collectively as power supply device 2.

The water quality of each of water to be treated and treated water is measured using well-known water quality measurement instrument(s) 5 (51 and 52). The quality of the water to be treated does not have to be measured. Water quality measurement instrument(s) 5 may be, for example, a conductivity meter that measures the conductivity of the water to be treated and the treated water, a resistivity meter that measures the resistivity of the water to be treated and the treated water, or a concentration meter that measures the ion concentration in the water to be treated and the treated water. The deionized water production system may also be equipped with a well-known flow meter (integrating flow meter) 6 that measures the discharge amount (production amount) of treated water from the demineralization chambers (D) of each of EDI devices 11 and 12.

Control device 3 is connected to water quality measurement instrument(s) 5 and flow meter 6 via known communication means, and measurement data of the water quality of each of the water to be treated and the treated water, as well as data on the production amount of the treated water, are transmitted. Control device 3 may receive values of output voltages (DC voltages) from each of power supply devices 21 and 22. Furthermore, control device 3 uses a pump (not shown) and valve 7 to control the supply and shut-off of the water to be treated to the concentration chambers (C) and the electrode chambers (E) of EDI devices 11 and 12. The concentrated water discharged from the concentration chambers (C) and the electrode water discharged from the electrode chambers (E) are each discharged into drain tank 8.

FIG. 5 shows an example in which the water to be treated is supplied to the concentration chambers (C) and electrode chambers (E) of EDI devices 11 and 12. The treated water may be supplied to the concentration chambers (C) and the electrode chambers (E), or water may be supplied to the concentration chambers (C) and the electrode chambers (E) from a system that is separate from the deionized water production system shown in FIG. 5. EDI device 1 may be configured so that one chamber serves as both the electrode chamber (E) and the concentration chamber (C). In this case, since the electrode chamber (E) and the concentration chamber (C) have the same flow path, the operation method is to pass water through only one of the chambers. In a configuration in which water is supplied to the concentration chamber (C) and the electrode chamber (E) from a system that is separate from the deionized water production system shown in FIG. 5, EDI device 1 can be operated without changing the flow rate of the water to be treated that is supplied to the demineralization chamber (D).

Control device 3 is connected to power supply device 2, the pump, and valve 7 via known communication means and can control the operations of power supply device 2, the pump, and valve 7. Control device 3 effects on/off control of power supply device 2 and also uses the pump and valve 7 to control the supply and shut-off of the water to be treated to the demineralization chamber (D) of EDI device 1 as well as to control the supply and shut-off of the water to be treated to the concentration chamber (C) and electrode chamber (E) of EDI device 1. Control device 3 also operates EDI device 1 in two operation modes (the water intake mode and the water intake and regeneration mode) to be described below. The communication means between control device 3 and, power supply device 2, the pump, valve 7, water quality measurement instrument(s) 5, and flow meter 6 may be any well-known wired communication means or wireless communication means, and any well-known communication standard may be used.

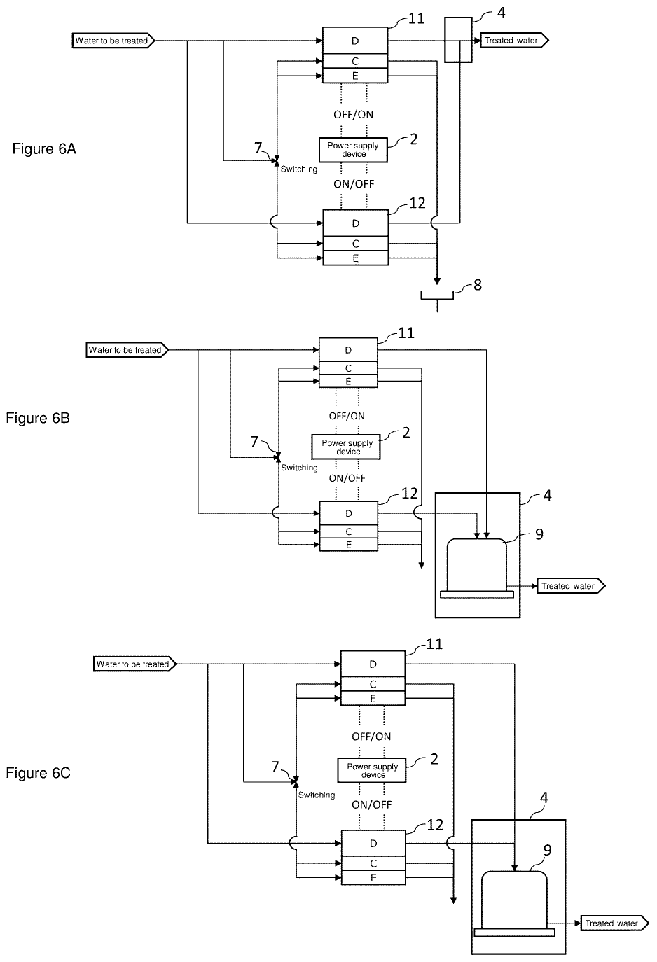

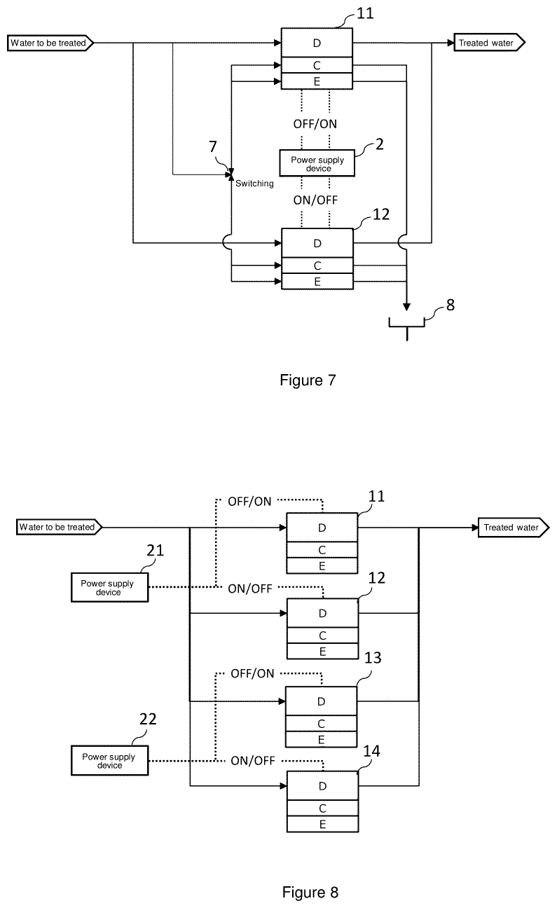

Confluence section 4 may be configured as shown in FIG. 6A, where the flow paths of treated water from EDI devices 11 and 12 are combined, or as shown in FIG. 6B, where treated water from EDI devices 11 and 12 is stored in common tank 9 and output as treated water. Alternatively, confluence section 4 may be a configuration that combines the configurations shown in FIGS. 6a and 6b, as shown in FIG. 6c. In FIGS. 6A to 6C, control device 3, water quality measurement instrument(s) 5, and flow meter 6 are omitted, and the communication paths between control device 3 and each of power supply device 2, valve 7, water quality measurement device(s) 5, and flow meter 6 are also omitted to prevent the drawings from becoming too complicated. Drain tank 8 is also omitted in FIGS. 6b and 6c. FIGS. 6a to 6c show an example of the configuration in which one power supply device 2 shown in FIG. 7 is shared by two EDI devices 11 and 12, as described below. The configurations and operation methods are otherwise the same as in the first embodiment, and redundant description thereof is therefore omitted.

As shown in FIG. 5, the deionized water production system of the second embodiment includes multiple (two in FIG. 5) EDI devices 1 with water flow paths connected in parallel in order to, for example, allow passage of water to be treated at a high flow rate to produce deionized water.

In the deionized water production system of the second embodiment, each of two EDI devices 1 is operated alternately in the water intake mode and the water intake and regeneration mode, and when one EDI device 1 is operated in the water intake mode, the other EDI device 1 is operated in the water intake and regeneration mode. In this case, the deionized water production system may include periods in which multiple EDI devices 1 are simultaneously operated in the water intake and regeneration mode.

In the case of a deionized water production system having three or more EDI devices 1 in the second embodiment, the operations of multiple EDI devices 1 in the water intake and regeneration mode are set to different start and end timings. For example, the implementation of sequential operations of multiple EDI devices 1 in the water intake and regeneration mode can be considered. Alternatively, operations of multiple EDI devices 1 in the water sampling and regeneration mode in the second embodiment are set to different start and end timings for each of the units that are grouped into two or more. For example, in the case of a deionized water production system that includes four EDI devices 1 having water flow paths connected in parallel, two sets of units each consisting of two EDI devices 1 may be provided, and when one unit is operated in the water intake mode, the other unit may be operated in the water intake and regeneration mode.

It should be noted that a deionized water production system having three or more EDI devices 1 may include EDI device 1 that does not switch operation modes and that, for example, always operates in the water intake and regeneration mode. That is, in the second embodiment, each of at least two EDI devices 1 among a plurality of EDI devices 1 is operated alternately in the water intake mode and the water intake and regeneration mode, and the operation in the water intake and regeneration mode in the plurality of EDI devices 1 that are operated alternately in the water intake mode and the water intake and regeneration mode is performed at at least two different start and end timings.

The operation mode of the plurality of EDI devices 1 may be switched by control device 3 using a timer or based on the water quality of the treated water measured by water quality measurement instrument(s) 5. When the operation mode is switched using a timer, control device 3 may, for example, alternately switch between the water intake and regeneration mode and the water intake mode based on the preset operating times for the water intake and regeneration mode and the water intake mode. When the operation mode is switched based on the water quality of the treated water measured by water quality measurement instrument(s) 5, control device 3 may, for example, switch to the water intake and regeneration mode if the water quality of the treated water deteriorates below a first threshold value that was previously set during operation in the water intake mode, and switch to the water intake and regeneration mode if the water quality of the treated water exceeds a second threshold value that was previously set during operation in the water intake and regeneration mode (i.e., if the water quality improves).

If the operation mode of each EDI device 1 is controlled by control device 3 in this manner, the treated water after combining will include the treated water from EDI device 1 that is operated in the water intake and regeneration mode. Therefore, in the deionized water production system of the second embodiment, the provision of confluence section 4 averages the water quality of the treated water from a plurality of EDI devices 1, whereby fluctuations in the water quality of the treated water after combining are suppressed. In addition, by including the water intake mode in the operation mode of EDI device 1, the amount of wastewater discharged from EDI device 1 can be reduced while reducing the power consumption of the overall deionized water production system.

The deionized water production system shown in FIG. 5 is an example of a configuration in which two power supply devices 21 and 22 are provided corresponding to two EDI devices 11 and 12. In such a configuration, for example, one EDI device 1 can always be operated in the water intake and regeneration mode. Even in this case, the operation mode of the other EDI device 1, i.e., at least one EDI device 1, includes the water intake mode, and the amount of wastewater discharged from EDI devices 1 can therefore be reduced while reducing the power consumption of the overall deionized water production system.

Furthermore, in the deionized water production system of the second embodiment, when at least one EDI device 1 is operated in the water intake and regeneration mode and another EDI device 1 is operated in the water intake mode, one power supply device 2 can be shared by the plurality of EDI devices 1. For example, FIG. 7 shows an example of a configuration in which one power supply device 2 is shared by two EDI devices 11 and 12. FIG. 8 shows an example of a configuration of a deionized water production system in which power supply device 21 is shared by two EDI devices 11 and 12 and power supply device 22 is shared by two EDI devices 13 and 14.

In a configuration in which one power supply device 2 is shared by a plurality of EDI devices 1, a period in which DC voltage is not supplied to all EDI devices 1, i.e., a period in which all EDI devices 1 are operated in the water intake mode, may be included to ensure the time required to switch the connection between power supply device 2 and EDI devices 1. In this case, a switching valve for switching the flow path for the water to be treated to EDI devices 11 and 12 may be used as valve 7. FIGS. 5, 6A to 6A, and 7 show examples of configurations using the switching valve as valve 7. The connection of power supply device 2 to the plurality of EDI devices 1 can be switched using a known switch (not shown) that can communicate with control device 3 and that can be operated by control device 3.

In FIG. 7, in the interest of simplifying the drawing, control device 3, water quality measurement instrument 5, and flow meter 6 are omitted and the communication paths between control device 3 and each of power supply device 2, valve (switching valve) 7, water quality measurement instrument 5, and flow meter 6 are also omitted. In FIG. 8, in addition to the components omitted in FIG. 7, the water flow paths to the concentration chambers (C) and the electrode chambers (D) as well as valve (switching valve) 7 and the water flow paths from the concentration chambers (C) and electrode chambers (D) as well as drain tank 8 are further omitted.

In this way, sharing one power supply device 2 among a plurality of EDI devices 1 allows the number of power supply devices 2 provided in the deionized water production system to be reduced, and therefore, the installation space for power supply devices 2 can be reduced. Furthermore, reducing the number of power supply devices 2 also enables the reduction of the cost of a deionized water production system having a plurality of EDI devices 1.

### Third Embodiment

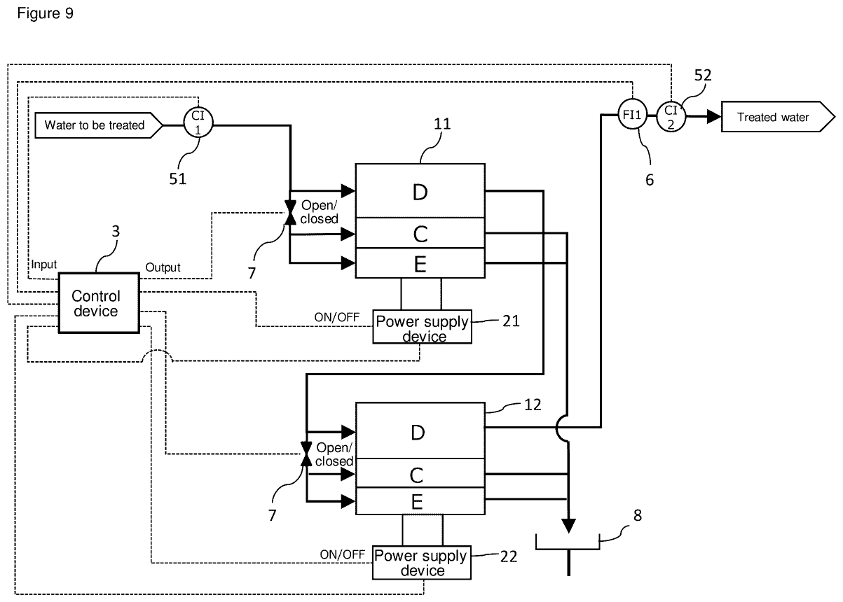

FIG. 9 is a block diagram showing an example of the configuration of a deionized water production system according to a third embodiment.

As shown in FIG. 9, the deionized water production system of the third embodiment includes a plurality of EDI devices 1 with water flow paths connected in series. In this configuration, for example, raw water stored in a storage tank or the like is passed through the demineralization chamber (D), the concentration chamber (C), and the electrode chamber (E) of first-stage EDI device 1, the treated water from first-stage EDI device 1 is then passed through the demineralization chamber (D), the concentration chamber (C), and the electrode chamber (E) of second-stage EDI device 1, following which the treated water from second-stage EDI device 1 is discharged as the treated water of the deionized water production system. Because the water flow paths of the plurality of EDI devices 1 are connected in series in the deionized water production system of the third embodiment, confluence section 4 shown in the second embodiment is not required. Furthermore, on-off valves may be used as valves 7 for controlling the supply and shut-off of water to the concentration chambers (C) and the electrode chambers (E) of EDI devices 1. Valves 7 (on-off valves) may be provided for each of the water flow paths to the concentration chambers (C) and the electrode chambers (E) of, for example, EDI devices 11 and 12. In the deionized water production system of the third embodiment, if the system includes a period in which the plurality of EDI devices 1 are simultaneously operated in the water intake and regeneration mode, an on-off valve may be provided for each of the water flow paths of the water to be treated to the concentration chambers (C) and the electrode chambers (E) of EDI devices 11 and 12. The configurations and operation methods are otherwise the same as in the second embodiment, and descriptions thereof will therefore be omitted.

In the deionized water production system of the third embodiment, the water flow paths of the plurality of EDI devices 1 are connected in series, with the result that the treated water from each stage of EDI device 1 is supplied to the demineralization chamber (D) of EDI device 1 in the following stage. Therefore, the deionization performance of the entire deionized water production system is improved, and treated water of better quality can be obtained than in the deionized water production system of the second embodiment in which the plurality of EDI devices 1 have water flow paths connected in parallel.

In the deionized water production system of the third embodiment, two EDI devices 1 are operated alternately in the water intake mode and the water intake and regeneration mode, one EDI device 1 being operated in the water intake mode when the other EDI device 1 is operated in the water intake and regeneration mode. That is, each of at least two EDI devices 1 among the plurality of EDI devices 1 is operated alternately in the water intake mode and the water intake and regeneration mode, and the operation in the water intake and regeneration mode in the plurality of EDI devices 1 that are operated alternately in the water intake mode and the water intake and regeneration mode is performed at least two different start and end timings. Controlling the operation mode of each EDI device 1 using control device 3 in this way enables a reduction of fluctuations in the water quality of the treated water in EDI device 1 in the following stage, as in the second embodiment. In addition, since the operation mode of each EDI device 1 includes the water intake mode, the amount of wastewater discharged from EDI device 1 can be reduced while reducing the power consumption of the entire deionized water production system.

Furthermore, if the deionized water production system of the third embodiment is of a configuration in which a plurality of power supply devices 2 corresponding to each EDI device 1 are provided, one EDI device 1 (for example, second-stage EDI device 1) may always be operated in the water intake and regeneration mode. Even in this case, because the operation mode of the other EDI device 1, i.e., at least one EDI device 1, includes the water intake mode, the amount of wastewater discharged from EDI device 1 can be reduced while reducing the power consumption of the entire deionized water production system. In a configuration in which EDI device 1 in a subsequent stage is always operated in the water intake and regeneration mode, treated water of better quality can be obtained from the deionized water production system than a configuration in which EDI device 1 in a preceding stage is always operated in the water intake and regeneration mode.

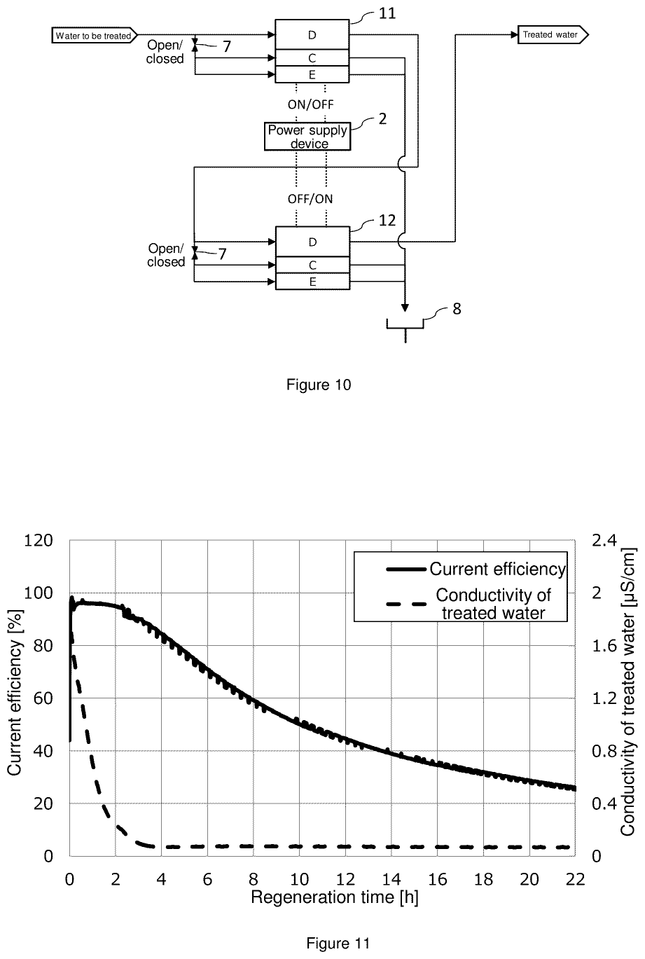

Furthermore, in the deionized water production system of the third embodiment, when at least one EDI device 1 is operated in the water intake and regeneration mode and another EDI device 1 is operated in the water intake mode, one power supply device 2 can be shared by the plurality of EDI devices 1. For example, FIG. 10 shows an example of a configuration in which one power supply device 2 is shared by two EDI devices 11 and 12. In the interest of simplifying the drawing in FIG. 10, control device 3, water quality measurement instrument(s) 5, and flow meter 6 are omitted, and the communication paths between control device 3 and each of power supply device 2, valve (on-off valve) 7, water quality measurement instrument(s) 5, and flow meter 6 are also omitted.

In a configuration in which one power supply unit 2 is shared by a plurality of EDI devices 1, a period in which DC voltage is not supplied to all EDI devices 1, i.e., a period in which all EDI devices 1 are operated in the water intake mode, may be included to switch between the destinations of the supply of DC voltage to the plurality of EDI devices 1.

If one power supply device 2 is shared by a plurality of EDI devices 1 in this way, the number of power supply devices 2 provided in the deionized water production system can be reduced, and the installation space for power supply devices 2 can therefore be reduced. Furthermore, reducing the number of power supply devices 2 also reduces the cost of a deionized water production system having a plurality of EDI devices 1.

### EXAMPLE

Working examples of the present invention will next be described.

First, the deionized water production system of the first embodiment shown in FIG. 1 will be shown to enable a reduction of both power consumption and the amount of waste water of EDI device 1 while also suppressing the deterioration of water quality of treated water by measuring the water quality of the treated water and then switching between the water intake and regeneration mode and the water intake mode using preset threshold values (first and second threshold values) as base points.

### (Basic Principle)

This basic principle shows that, when regenerating an ion exchanger in EDI device 1, the efficiency of power utilization for regeneration is improved when the proportion of the salt form of the ion exchanger is high. Here, a salt form (chloride ion form) ion exchange resin was prepared as the anion exchanger. The demineralization chamber of EDI device 1 was filled with this anion exchanger together with a regenerated cation exchange resin. When pure water is passed through each of the demineralization chamber, the concentration chamber, and the electrode chamber to regenerate the ion exchanger, the proportion of the current used to discharge chloride ions (regenerate the ion exchange resin) was calculated based on the concentration of chloride ions discharged as concentrated water relative to the amount of electricity that energized EDI device 1 (i.e., the current efficiency), and this efficiency was graphed. The graph also shows the progression of the water quality of treated water based on the measurement results of the conductivity. EDI device 1 is configured to operate as a single unit.

FIG. 11 is a graph showing the change in the current efficiency and the conductivity of treated water with respect to the regeneration time of the ion exchanger. Because the conductivity value decreases with lower ion content, water quality improves as the conductivity value decreases.

As shown in FIG. 11, the current efficiency can be kept at a high efficiency of 90% or more for about two hours after the start of electrically energizing EDI device 1, but thereafter the efficiency gradually decreases, reaching 50% or less after 10 hours. The production of treated water with a conductivity of 1 μS/cm (0.1 mS/m) or less was confirmed when electricity was first applied to the EDI device 1, and this result indicates that better water quality as specified in the Japanese Industrial Standards (JIS K 0557) can be achieved in approximately one hour after the start of energizing EDI device 1.

Therefore, the current efficiency of EDI device 1 can be seen to be higher when the device is operated in a state in which the proportion of the salt form of the ion exchanger is high. Accordingly, operation in the water intake and regeneration mode, in which EDI device 1 is energized, is started before the water quality falls below the value required for the deionized water production system, and when the water quality recovers to some extent, energizing of EDI device 1 is stopped and operation switches to the water intake mode. This allows EDI device 1 to be operated at high current efficiency at all times while suppressing the deterioration of the water quality of the treated water.

### First Example

In the first example, a case is shown in which conductivity is measured as the water quality of the treated water in the deionized water production system of the first embodiment, and the water intake and regeneration mode and the water intake mode are switched on the basis of two threshold values of conductivity. An EDI device (EDI-HF2-0500 stack) manufactured by Organo Corporation was used as EDI device 1, and the water to be treated was constantly passed through the demineralization chamber (D) at 750 L/h throughout the water intake and regeneration mode and the water intake mode. During operation in the water intake and regeneration mode, EDI device 1 was set to a constant-current operation at a DC current of 2.5 A. Permeated water having a conductivity of 4±0.2 μS/cm that had permeated two stages of reverse osmosis membrane devices connected in series was supplied to the demineralization chamber (D) of EDI device 1. The conditions were the same for the second example described below.

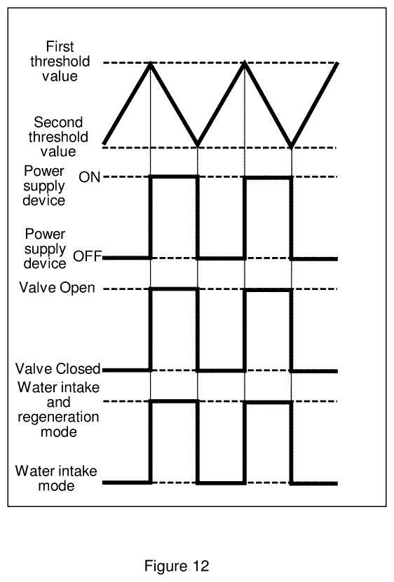

In the first example, the first threshold value of conductivity was set to 0.95 μS/cm, and the second threshold value was set to 0.40 μS/cm. As mentioned above, the lower the conductivity of the treated water, the better the water quality. Therefore, as shown in FIG. 12, when the conductivity increased to the first threshold value, the operation was switched to the water intake and regeneration mode, and when the conductivity decreased to the second threshold value, the operation was switched to the water intake mode, and these operations were repeated.

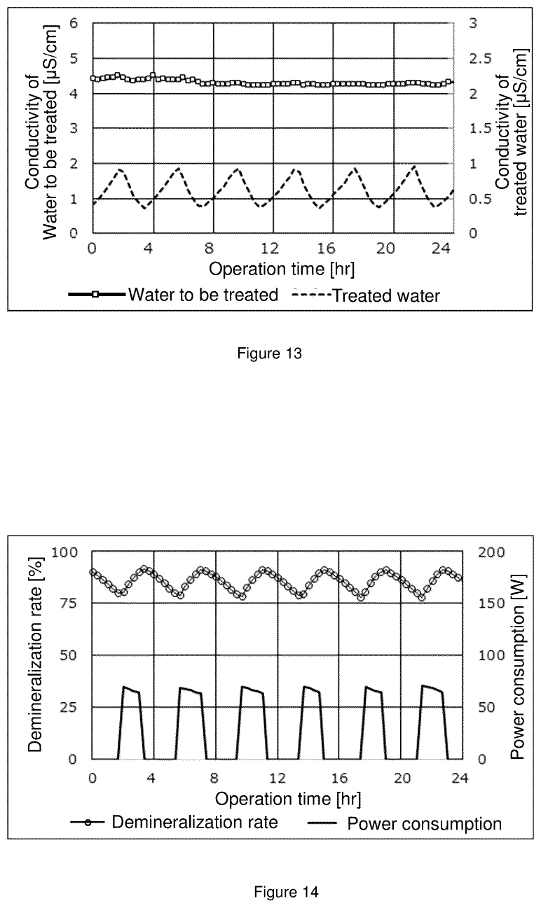

An example of the changes in the conductivity of the water to be treated and the conductivity of the treated water at this time is shown in FIG. 13, and an example of the changes in the demineralization rate of the treated water and the power consumption of EDI device 1 is shown in FIG. 14. The demineralization rate was calculated using the following formula:

Demineralization rate [%]={1−(conductivity of treated water+conductivity of water to be treated)}×100

The power consumption [W] was calculated by output current [A]×output voltage [V] of the power supply device during the energized operation of EDI device 1.

### Second Example

In the second example, a case is shown in which resistivity is measured as the water quality of the treated water in the deionized water production system of the first embodiment, and the water intake and regeneration mode and the water intake mode are switched on the basis of two threshold values of resistivity.

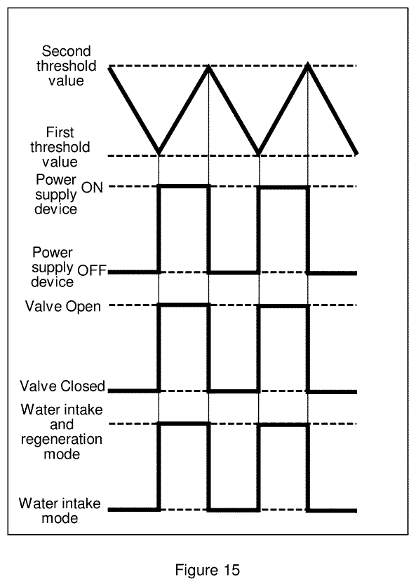

In the second example, the first threshold value of resistivity was set to 3 MΩ·cm, and the second threshold value of resistivity was set to 5 MΩ·cm. The resistivity is the inverse of the conductivity, meaning that the higher the value, the better the water quality. As a result, as shown in FIG. 15, when the resistivity decreased to the first threshold value, the operation was switched to the water intake and regeneration mode, and when the resistivity increased to the second threshold value, the operation was switched to the water intake mode, and these operations were repeated.

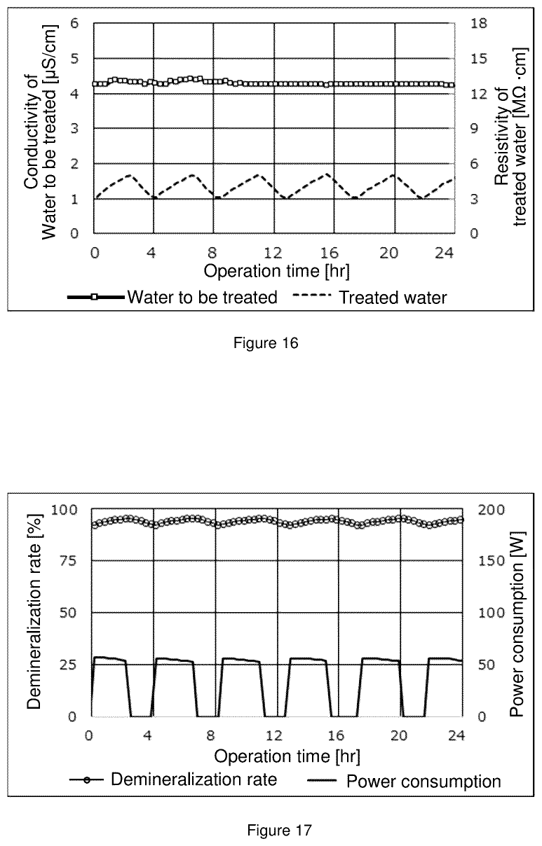

An example of the changes in the conductivity of the water to be treated and the resistivity of the treated water at this time is shown in FIG. 16, and an example of the changes in the demineralization rate of the treated water and the power consumption of EDI device 1 is shown in FIG. 17. The demineralization rate was calculated using the equation presented in the first example.

### Third Example

In the third example, a case is shown in which the concentration is measured as the water quality of the treated water in the deionized water production system of the first embodiment, and the water intake and regeneration mode and the water intake mode are switched on the basis of two threshold values of concentration. Concentrations (having as units, for example: μg/l) of, for example, calcium, sodium, silica, boron, carbonic acid, and TOC (Total Organic Carbon) are considered as the objects of measurement. The threshold value set for the concentration varies depending on the object of measurement, but as in the first embodiment, the lower the value, the better the water quality. Therefore, two threshold values with the relationship of first threshold value>second threshold value were set. In the third example, as in the first example shown in FIG. 12, when the concentration increased to the first threshold value, the operation was switched to the water intake and regeneration mode, and when the concentration decreased to the second threshold value, the operation was switched to the water intake mode, and these operations were repeated.

In the first to third examples described above, examples were shown in which a first threshold value and a second threshold value were set for the same type of measurement values, but the first threshold value and the second threshold value may also be set for different types of measurement values. For example, a conductivity meter and a concentration meter may be prepared as water quality measurement instruments 5, and the first threshold value may be set to a conductivity value and the second threshold value may be set to a concentration value. Alternatively, the first threshold value may be set to the concentration value and the second threshold value may be set to the conductivity value.

### First Comparative Example

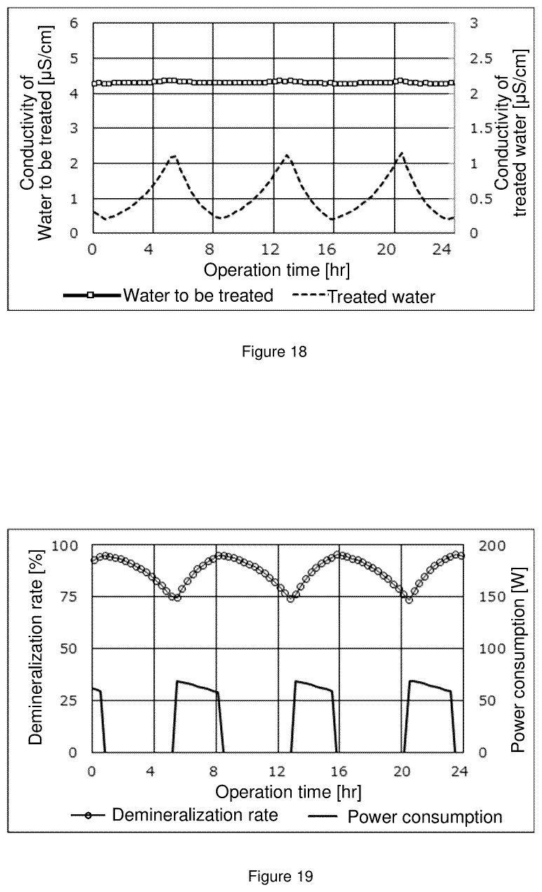

The first comparative example is a case in which a 3-hour operation in the water intake and regeneration mode and a 5-hour operation in the water intake mode were repeated alternately in the deionized water production system of the first embodiment. In the first comparison example, the system was operated by switching between the water intake and regeneration mode and the water intake mode using a timer and without monitoring the water quality of the treated water. FIG. 18 shows an example of the changes in the conductivity of the water to be treated and the conductivity of the treated water, and FIG. 19 shows an example of the changes in the demineralization rate of the treated water and the power consumption of EDI device 1. The demineralization rate was calculated using the equation presented in the first example.

### Second Comparative Example

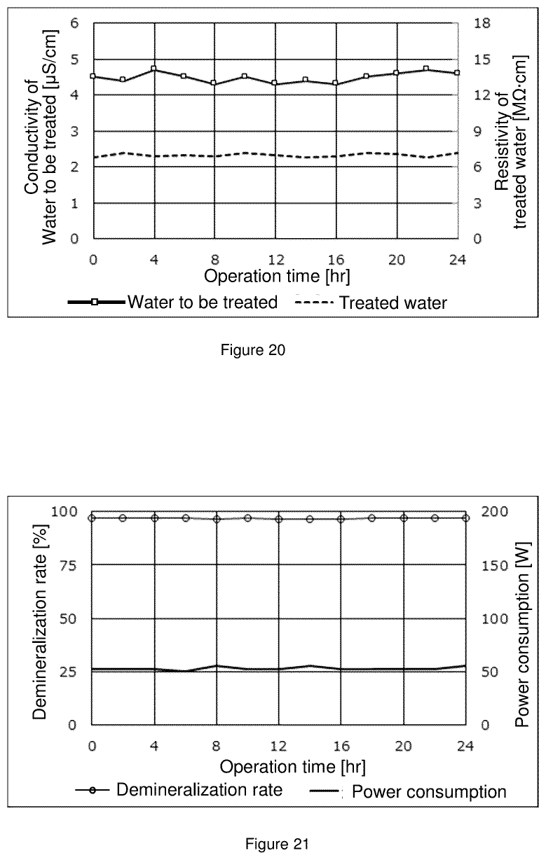

The second comparative example is a case in which the deionized water production system of the first embodiment is always operated in the water intake and regeneration mode. In other words, this example is an case in which the conventional (normal) operation mode is implemented in the deionized water production system. FIG. 20 shows an example of the changes in the conductivity of the water to be treated and the resistivity of the treated water, and FIG. 21 shows an example of the changes in the demineralization rate of the treated water and the power consumption of EDI device 1. The demineralization rate was calculated using the equation presented in the first example.

### (First Comparison Results)

Table 1 shows the results of a comparison of the performance (power consumption, wastewater amount, and demineralization rate) during 24-hour operation in the above-mentioned first embodiment, second embodiment, first comparative example, and second comparative example.

TABLE 1

| | Power consumption | | Amount of wastewater | | Demineralization rate [%] | | |
|---|---|---|---|---|---|---|---|
| | | Relative | | Relative | | | Fluctuation |
| | Wh/day | ratio | L/day | ratio | Minimum | Maximum | range |
| First | 604 | 0.48 | 630 | 0.38 | 77.6 | 91.3 | 13.7 |
| example | | | | | | | |
| Second | 849 | 0.67 | 1074 | 0.64 | 92.1 | 95.4 | 3.3 |
| example | | | | | | | |
| First | 597 | 0.47 | 654 | 0.39 | 73.5 | 95.2 | 21.7 |
| comparative | | | | | | | |
| example | | | | | | | |
| Second | 1270 | 1.00 | 1680 | 1.00 | 96.6 | 97.0 | 0.4 |
| comparative | | | | | | | |
| example | | | | | | | |

As can be seen from Table 1, compared to the power consumption of EDI device 1 in the second comparative example, the power consumption of EDI device 1 in the first embodiment was reduced by 52%, and the power consumption of EDI device 1 in the second embodiment was reduced by 33%. Similarly, compared to the amount of wastewater discharged from EDI device 1 in the second comparative example, the amount of wastewater discharged from EDI device 1 in the first embodiment was reduced by 62%, and the amount of wastewater discharged from EDI device 1 in the second embodiment was reduced by 36%.

As mentioned above, EDI device 1 is usually used in a constantly energized state as shown in the second comparative example, and as a result, in the deionized water production systems shown in the first and second examples, the power consumption and the wastewater amount of EDI device 1 can be reduced compared to a conventional method.

Furthermore, compared to the fluctuation range (0.4) of the demineralization rate in the second comparative example, the fluctuation range in the first example was 13.73, and the fluctuation range in the second example was 3.3. Therefore, the fluctuation range of the demineralization rate was larger than that of the second comparative example in which the power was constantly applied, but the fluctuation range of the demineralization rate could be reduced more than that of the first comparative example in which the water intake and regeneration mode and the water intake mode were switched by simply using a timer.

Therefore, by appropriately setting the threshold values (first threshold value and second threshold value) and switching between the water intake and regeneration mode and the water intake mode based on the measured value of the water quality of the treated water using the threshold value as a base point, the power consumption and the amount of wastewater of EDI device 1 can be reduced while controlling the deterioration of the water quality of the treated water.

### Third Comparative Example

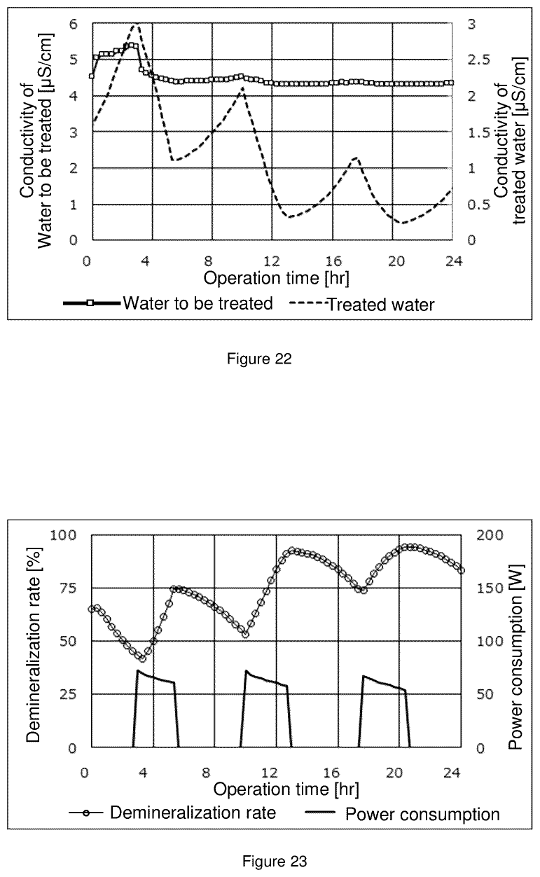

In the third comparative example, under the same conditions as in the first comparative example, the conductivity of the water to be treated that was supplied to EDI device 1 was temporarily increased to 5.3 μS/cm. An example of changes in the conductivity of the water to be treated and the conductivity of the treated water is shown in FIG. 22, and an example of changes in the demineralization rate of the treated water and the power consumption of EDI device 1 is shown in FIG. 23.

As shown in FIGS. 22 and 23, in the case of an operation that uses a timer to switch between the water intake mode and the water intake and regeneration mode, if the water quality of the water to be treated fluctuates, the water quality of the treated water will also deteriorate in accordance with the fluctuation. By measuring the water quality of the treated water and using control device 3 to switch between the water intake and regeneration mode and the water intake mode based on the measured value of the water quality of the treated water using the preset threshold value as a base point as in the present invention, fluctuations in the water quality of the treated water can be controlled within a specified range even if the water quality of the water to be treated fluctuates.

A deionized water production system can therefore be obtained that can reduce the power consumption and the amount of wastewater of EDI device 1 while controlling the deterioration of the water quality of the treated water.

### (First Example of a Modification)

For example, in a configuration in which a reverse osmosis membrane device equipped with a well-known reverse osmosis membrane (RO membrane) was provided in the stage preceding EDI device 1 shown in FIG. 1, the amount of wastewater discharged from the reverse osmosis membrane device was greater than the amount of wastewater discharged from EDI device 1, resulting in a very large amount of wastewater discharged from the entire deionized water production system. In the first modified example, an example of operation is proposed for further reducing the amount of wastewater discharged from the entire deionized water production system.

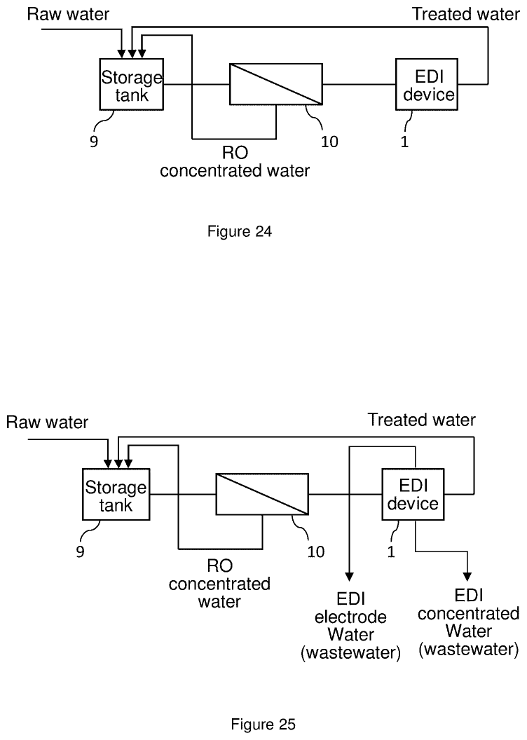

FIG. 24 is a block diagram showing an example of a modification of the operation of the deionized water production system of the first embodiment, and FIG. 25 is a block diagram showing another example of a modification of the operation of the deionized water production system of the first embodiment. FIGS. 24 and 25 show an example of a circulation operation in which the deionized water production system includes reverse osmosis membrane device 8 in the stage preceding EDI device 1. Raw water is supplied to reverse osmosis membrane device 8 from storage tank 9 in which the raw water is stored, the permeated water from reverse osmosis membrane device 8 is sent to the demineralization chamber of EDI device 1 as the water to be treated, and the treated water from EDI device 1 is returned to storage tank 9.

The circulation operation is performed when there is no demand to use the treated water at a stage following EDI device 1. When there is no demand to use the treated water, the operation of the entire deionized water production system may be stopped. However, when the operation of the entire deionized water production system is stopped, the water quality may deteriorate in the system due to water stagnation in some areas. Therefore, in general deionized water production systems, the circulation operation is often carried out when there is no demand for the treated water.

In the example of operation of the deionized water production system shown in FIG. 24, the treated water from EDI device 1 (operated in the water intake mode) and wastewater (RO concentrated water) from reverse osmosis membrane device 10 are each supplied to storage tank 9 and circulated. In the example of operation of the deionized water production system shown in FIG. 25, the treated water from EDI device 1 (operated in the water intake and regeneration mode) and wastewater (RO concentrated water) from reverse osmosis membrane device 10 are each supplied to storage tank 9 and circulated. FIG. 24 and FIG. 25 each show only the main components necessary for explaining the modified operation example. The deionized water production systems shown in FIGS. 24 and 25 also include power supply device 2, control device 3, water quality measurement instrument(s) 5, flow meter 6, valve 7, a pump, drain tank 8, as well as the deionized water production system shown in FIG. 1.

In the example of the operation of the deionized water production system shown in FIG. 24, the treated water from EDI device 1 (operated in the water intake mode) and the wastewater from reverse osmosis membrane device 8 are each supplied to storage tank 9 and thus circulated, and there is consequently no need to newly supply raw water to storage tank 9. Therefore, the amount of raw water used during a circulation operation becomes zero. In other words, the deionized water production system can be operated in a state in which the treated water and the wastewater are circulated without discharging any wastewater to the outside. Therefore, by providing a period during the circulation operation in which no drainage is discharged to the outside, the amount of wastewater discharged from the entire deionized water production system can be significantly reduced.

On the other hand, in the example of operation of the deionized water production system shown in FIG. 25, the concentrated water discharged from the concentration chamber (C) and the electrode water discharged from the electrode chamber (E) of EDI device 1 (operated in the water intake and regeneration mode) are each discharged to the outside, and raw water must therefore be newly supplied to storage tank 9 by an amount equivalent to the discharged water. Therefore, the amount of raw water used during a circulation operation is greater than in the example of operation shown in FIG. 24. In a conventional deionized water production system, a circulation operation was performed according to the example of operation shown in FIG. 25.

Since the electrode water discharged from the electrode chamber (E) of EDI device 1 contains oxidizing agents generated by the electrode reaction, the electrode water cannot be returned to storage tank 9 that is installed in the stage preceding reverse osmosis membrane device 8 that includes the reverse osmosis (RO) membrane, which generally deteriorates due to oxidizing agents, or in a stage preceding EDI device 1 that includes the demineralization chamber (D) that is filled with ion exchangers. The concentrated water discharged from the concentration chamber (C) of EDI device 1 can be returned to storage tank 9 installed in the stage preceding reverse osmosis membrane device 8, but in the circulation operation shown in FIG. 25, the concentrated water is also discharged to the outside.

In the circulation operation of the deionized water production system shown in FIG. 25, the RO concentrated water is returned from osmosis membrane device 8 to storage tank 9, and raw water is supplied to storage tank 9 along with the electrode water and the concentrated water discharged from EDI device 1, with the result that the component concentration of the raw water in storage tank 9 increases over time. Continuing the circulation operation shown in FIG. 25 may therefore impede maintenance of the performance of the deionized water production system.

According to the first example of a modification, alternately performing the circulation operation in the water intake mode shown in FIG. 24 and the circulation operation in the water intake and regeneration mode shown in FIG. 25 can reduce the power consumption and the wastewater amount of the deionized water production system compared to a conventional circulation operation.

The example of the circulation operation of the deionized water production system of the first embodiment shown in FIGS. 24 and 25 may be applied to a configuration that lacks reverse osmosis membrane device 8 shown in FIG. 1. That is, the water intake mode and the water intake and regeneration mode may include a period of time in which the treated water from EDI device 1 is supplied to storage tank 9. In this case, including the circulation operation in the water intake mode enables a reduction of the power consumption and the wastewater amount of the deionized water production system compared to a conventional circulation operation.

### Fourth Example

In the fourth example, the deionized water production system includes two EDI devices 11 and 12 with water flow paths connected in parallel and one power supply device 2 that is shared by two EDI devices 11 and 12, as shown in the second embodiment. In addition, as shown in FIG. 7, one power supply device 2 can be shared by two EDI devices 11 and 12 because when one EDI device 1 is operated in the water intake mode, the other EDI device 1 is operated in the water intake and regeneration mode.

An EDI device (EDI-HF2-0500 stack) manufactured by Organo Corporation was used as EDI device 1, and the water to be treated was constantly passed through the demineralization chamber (D) at 750 L/h throughout the water intake and regeneration mode and the water intake mode. During operation in the water intake and regeneration mode, EDI device 1 was set to constant-current operation with a DC current of 2.5 A. Permeated water having a conductivity of 4±0.2 μS/cm that had permeated two stages of reverse osmosis membrane devices connected in series was supplied to the demineralization chamber (D) of EDI device 1. The water to be treated passed through the concentration chamber of EDI device 1 at 50 L/h only during the water intake and regeneration mode, and the water to be treated passed through the electrode chamber at 20 L/h only during the water intake and regeneration mode. These conditions were the same for the fourth comparative example described below.

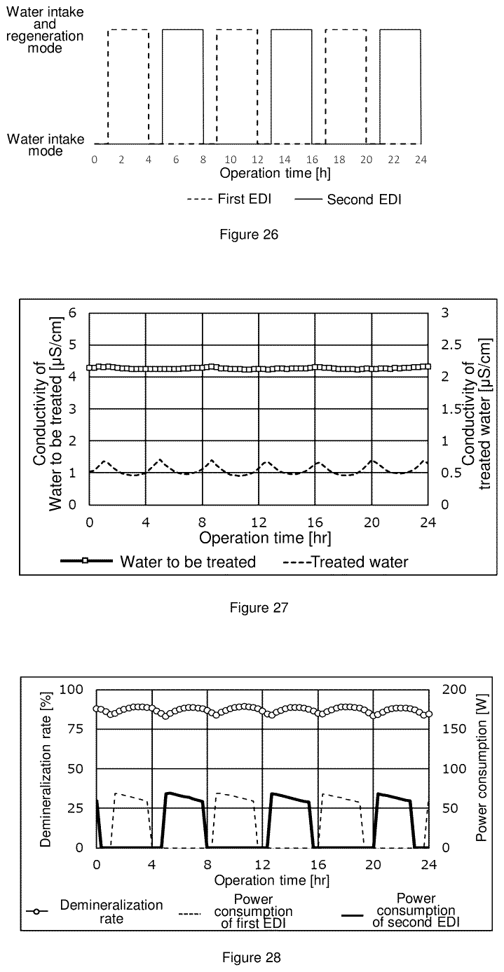

The operation mode of each EDI device 1 was switched using a timer. During the period when first EDI device 11 was operated in the water intake mode, second EDI device 11 was operated in the water intake and regeneration mode, and during the period when second EDI device 12 was operated in the water intake mode, first EDI device 11 was operated in the water intake and regeneration mode. The operation time in the water intake mode was 5 hours, and the operation time in the water intake and regeneration mode was 3 hours, and the water intake mode and the water intake and regeneration mode were operated alternately. In this case, before and after the period in which either first EDI device 11 or second EDI device 12 was operated in the water intake and regeneration mode, there was a period (=1 hour) in which both first EDI device 11 and second EDI device 12 were operated in the water intake mode. An example of the transition of the operation modes of first EDI device 11 and second EDI device 12 over 24 hours (=1 day) is shown in FIG. 26.

An example of changes in the conductivity of the water to be treated and the conductivity of the treated water is shown in FIG. 27, and an example of changes in the demineralization rate of the treated water and the power consumption of first EDI device 11 and second EDI device 12 is shown in FIG. 28. For conductivity, the lower the value, the cleaner the water quality. The demineralization rate was calculated using the following formula:

Demineralization rate [%]={1−(conductivity of treated water+conductivity of water to be treated)}×100

The power consumption [W] was calculated by output current [A]×output voltage [V] of power supply device 2 during the energized operation of EDI device 1.

### Fourth Comparative Example

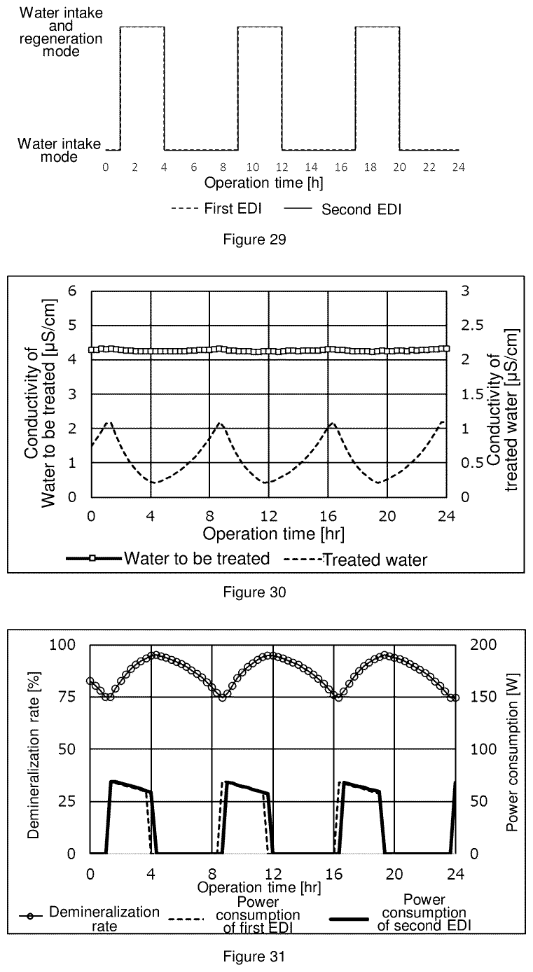

The deionized water production system of the fourth comparative example included two EDI devices 11 and 12 with water flow paths connected in parallel, and two power supply devices 21 and 22 corresponding to two EDI devices 11 and 12, as shown in the second embodiment in FIG. 5. In the fourth comparative example, the operation modes of first EDI device 11 and second EDI device 12 were switched using a timer, and first EDI device 11 and second EDI device 12 were simultaneously operated in the water intake mode for 5 hours and then were simultaneously operated in the water intake and regeneration mode for 3 hours. Operation in the water intake mode and operation in the water intake and regeneration mode were alternately repeated. The transition of the operation modes of first EDI device 11 and second EDI device 12 over a 24-hour period (=1 day) is shown in FIG. 29.

An example of changes in the conductivity of the water to be treated and the conductivity of the treated water is shown in FIG. 30, and an example of changes in the demineralization rate of the treated water and the power consumption of first EDI device 11 and second EDI device 12 is shown in FIG. 31. The formulas for calculating the demineralization rate and the power consumption [W] are the same as in the first and fourth examples.

### Fifth Example

In the fifth example, as shown in the third example, the deionized water production system included two EDI devices 1 with water flow paths connected in series and two power supply devices 2 corresponding to two EDI devices 1. First (front) EDI device 11 was operated alternately in the water intake mode and the water intake and regeneration mode, and second (rear) EDI device 12 was always operated in the water intake and regeneration mode.

An EDI-HF2-0500 stack manufactured by Organo Corporation was used as first EDI device 11, and first EDI device 11 was operated under the same conditions as in the fourth example. When the water quality (resistivity) of the treated water fell below 3 MΩ·cm, the water intake and regeneration mode was implemented, and when the water quality of the treated water rose above 5 MΩ·cm, the operation was shifted to the water intake mode. This process was repeated.

An EDI-HF2-0500 stack manufactured by Organo Corporation was used as second EDI device 12. The water to be treated was constantly passed through the demineralization chamber at 680 L/h, the water to be treated was passed through the concentration chamber at 50 L/h, and the water to be treated was passed through the electrode chamber at 20 L/h. Power supply device 22 was operated at a constant current of 2.5 A.

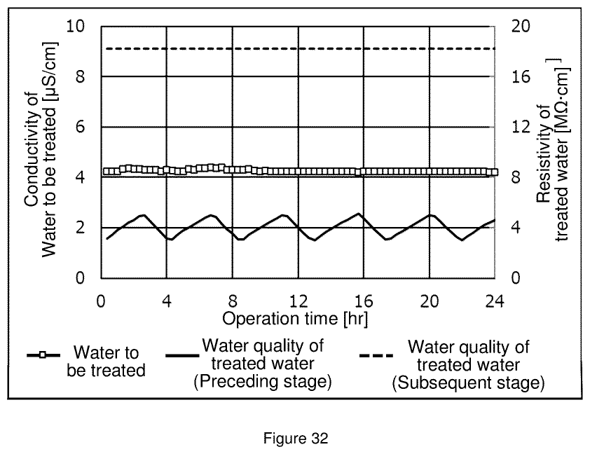

FIG. 32 shows an example of changes in the water quality (conductivity) of the treated water and the water quality (resistivity) of the treated water in first EDI system 11 in the preceding stage and second EDI system 12 in the subsequent stage. Resistivity is the inverse of conductivity, and the higher the value, the better the water quality.

### (Second Comparison Results)

As shown in the fourth comparative example, operating each of first EDI device 11 and second EDI device 12 simultaneously in the water intake mode and the water intake and regeneration mode results in relatively significant fluctuation of the quality of the treated water, as shown in FIG. 30. In contrast, operating one EDI device 1 in the water intake mode during a period in which the other EDI device 1 is operated in the water intake and regeneration mode as in the fourth example enables suppression of the fluctuations in the water quality of the treated water, as shown in FIG. 27.

Similarly, operating each of first EDI device 11 and second EDI device 12 simultaneously in the water intake mode and the water intake and regeneration mode as in the fourth comparative example results in relatively significant fluctuation of the demineralization rate, as shown in FIG. 31. On the other hand, operating one EDI device 1 in the water intake mode during a period in which the other EDI device 1 is operated in the water intake and regeneration mode as in the fourth example suppresses the fluctuations in the demineralization rate, as shown in FIG. 28.

Therefore, according to the deionized water production system, the plurality of EDI devices 1 can always be operated with high current efficiency while controlling fluctuations in the water quality of the treated water.

In addition, including the above water intake mode in the operation of the deionized water production system enables a reduction of the power consumption of EDI device 1 and the amount of wastewater discharged from EDI device 1 compared to a conventional deionized water production system. Therefore, the deionized water production system of this example enables a reduction of the power consumption and the amount of wastewater of the deionized water production system while suppressing the deterioration of the water quality of the treated water.

1. A method of operating a deionized water production system that produces deionized water from water to be treated using an electrodeionization device, comprising:
providing a water intake mode in which the water to be treated is passed through a demineralization chamber of the electrodeionization device to obtain treated water when the electrodeionization device is not energized, and
a water intake and regeneration mode which is operated alternately with the water intake mode and in which the water to be treated is passed through the demineralization chamber to obtain the treated water and water is passed through at least one of a concentration chamber and an electrode chamber of the electrodeionization device while the electrodeionization device is energized;
measuring water quality of the treated water; and
providing a first threshold value, which is preset for the measured value of the water quality of the treated water, to prevent the water quality of the treated water from deteriorating below a predetermined value, and switching between the water intake and regeneration mode and the water intake mode based on the measured value using the first threshold value as a base point.

2. The method of operating the deionized water production system according to claim 1, further comprising a second threshold value for switching from the water sampling and regeneration mode to the water sampling mode.

3. The method of operating the deionized water production system according to claim 1, wherein the measured value is at least one of conductivity, specific resistance, and concentration of the treated water.

4. The method of operating the deionized water production system according to claim 2, wherein the measured value is a conductivity, and the second threshold value is lower than the first threshold value, and
wherein when the conductivity reaches the first threshold value, the electrodeionization device is operated in the water intake and regeneration mode, and when the conductivity reaches the second threshold value, the electrodeionization device is operated in the water intake mode.

5. The method of operating the deionized water production system according to claim 2, wherein the measured value is a resistivity, and the second threshold value is higher than the first threshold value, and
wherein when the resistivity reaches the first threshold value, the electrodeionization device is operated in the water intake and regeneration mode, and when the resistivity reaches the second threshold value, the electrodeionization device is operated in the water intake mode.

6. The method of operating the deionized water production system according to claim 2, wherein the measured value is a concentration, and the second threshold value is lower than the first threshold value, and
wherein when the concentration reaches the first threshold value, the electrodeionization device is operated in the water intake and regeneration mode, and when the concentration reaches the second threshold value, the electrodeionization device is operated in the water intake mode.

7. A method of operating a deionized water production system that produces deionized water from water to be treated using a plurality of electrodeionization devices that have water flow paths connected in parallel or in series, comprising:
providing a water intake and regeneration mode in which the water to be treated is passed through a demineralization chamber of an electrodeionization device to obtain treated water and water is passed through at least one of a concentration chamber and an electrode chamber of the electrodeionization device while the electrodeionization device is energized with a first current, and
a water intake mode in which the water to be treated is passed through the demineralization chamber of the electrodeionization device to obtain the treated water in an energized state in which the electrodeionization device is energized with a second current lower than the first current or in an unenergized state in which the electrodeionization device is not energized;
operating each of at least two electrodeionization devices among the plurality of electrodeionization devices alternately in the water intake mode and the water intake and regeneration mode; and
performing, at least two different start and end timings, the operation in the water intake and regeneration mode in the plurality of electrodeionization devices that are operated alternately in the water intake mode and the water intake and regeneration mode.

8. A method of operating a deionized water production system that produces deionized water from water to be treated using a plurality of electrodeionization devices that have water flow paths connected in parallel or in series, comprising:
providing a water intake and regeneration mode in which the water to be treated is passed through a demineralization chamber of an electrodeionization device to obtain treated water and water is passed through at least one of a concentration chamber and an electrode chamber of the electrodeionization device while the electrodeionization device is energized with a first current, and
a water intake mode in which the water to be treated is passed through the demineralization chamber of the electrodeionization device to obtain the treated water in an energized state in which the electrodeionization device is energized with a second current lower than the first current or in an unenergized state in which the electrodeionization device is not energized;
operating at least one first electrodeionization device among the plurality of electrodeionization devices alternately in the water intake mode and the water intake and regeneration mode; and
operating a second electrodeionization device that is different from the first electrodeionization device in the water intake and regeneration mode.

9. A deionized water production system comprising:
an electrodeionization device that produces deionized water from water to be treated;
a power supply device that applies a required DC voltage to the electrodeionization device;
a water quality measurement instrument that measures a water quality of treated water obtained by passing the water to be treated through a demineralization chamber of the electrodeionization device; and
a control device that provides a water intake mode in which the water to be treated is passed through the demineralization chamber of the electrodeionization device to obtain the treated water when the electrodeionization device is not energized, and a water intake and regeneration mode that is operated alternately with the water intake mode and in which the water to be treated is passed through the demineralization chamber to obtain the treated water and water is passed through at least one of a concentration chamber and an electrode chamber of the electrodeionization device while the electrodeionization device is energized, wherein the control device has a first threshold value that is preset for a measured value of the water quality of the treated water to prevent the water quality of the treated water from deteriorating below a predetermined value and switches between the water intake and regeneration mode and the water intake mode based on the measured value using the first threshold value as a base point.

10. The deionized water production system according to claim 9, further comprising a reverse osmosis membrane device in which permeated water that has passed through a reverse osmosis membrane is passed through the desalination chamber as the water to be treated.

11. A deionized water production system comprising:
a plurality of electrodeionization devices that produce deionized water from water to be treated and that have flow paths connected in series;
a power supply device that applies a required DC voltage to an electrodeionization device; and
a control device that provides a water intake and regeneration mode, in which the water to be treated is passed through a demineralization chamber of the electrodeionization device to obtain treated water and water is passed through at least one of a concentration chamber and an electrode chamber of the electrodeionization device while the electrodeionization device is energized with a first current, and a water intake mode in which the water to be treated is passed through the demineralization chamber of the electrodeionization device to obtain the treated water in an energized state in which the electrodeionization device is energized with a second current lower than the first current or in an unenergized state in which the electrodeionization device is not energized, wherein the control device operates each of at least two electrodeionization devices among the plurality of electrodeionization devices alternately in the water intake mode and the water intake and regeneration mode,
wherein the control device performs, at least two different start and end timings, an operation in the water intake and regeneration mode in the plurality of electrodeionization devices that are operated alternately in the water intake mode and the water intake and regeneration mode.

12. A deionized water production system comprising:
a plurality of electrodeionization devices that produce deionized water from water to be treated and that have water flow paths connected in series;
a power supply device that applies a required DC voltage to an electrodeionization device; and
a control device that provides a water intake and regeneration mode in which the water to be treated is passed through a demineralization chamber of the electrodeionization device to obtain treated water and water is passed through at least one of a concentration chamber and an electrode chamber of the electrodeionization device while the electrodeionization device is energized with a first current, and a water intake mode in which the water to be treated is passed through the demineralization chamber of the electrodeionization device to obtain the treated water in an energized state in which the electrodeionization device is energized with a second current lower than the first current or in an unenergized state in which the electrodeionization device is not energized, wherein the control device operates at least one first electrodeionization device among the plurality of electrodeionization devices alternately in the water intake mode and the water intake and regeneration mode,
wherein the control device operates a second electrodeionization device that is different from the first electrodeionization device in the water intake and regeneration mode.

13. A deionized water production system comprising:
a plurality of electrodeionization devices that produce deionized water from water to be treated and that have water flow paths connected in parallel;
a power supply device that applies a required DC voltage to an electrodeionization device;
a control device that provides a water intake and regeneration mode in which the water to be treated is passed through a demineralization chamber of the electrodeionization device to obtain treated water and water is passed through at least one of a concentration chamber and an electrode chamber of the electrodeionization device while the electrodeionization device is energized with a first current, and a water intake mode in which the water to be treated is passed through the demineralization chamber of the electrodeionization device to obtain the treated water in an energized state in which the electrodeionization device is energized with a second current lower than the first current or in an unenergized state in which the electrodeionization device is not energized, wherein the control device operates each of at least two electrodeionization devices among the plurality of electrodeionization devices alternately in the water intake mode and the water intake and regeneration mode; and
a confluence section that combines the treated water from the plurality of electrodeionization devices,
wherein the control device performs, at least two different start and end timings, an operation in the water intake and regeneration mode in the plurality of electrodeionization devices that are operated alternately in the water intake mode and the water intake and regeneration mode.

14. An deionized water production system comprising:
a plurality of electrodeionization devices that produce deionized water from water to be treated and that have water flow paths connected in parallel;
a power supply device that applies a required DC voltage to an electrodeionization device;
a control device that provides a water intake and regeneration mode in which the water to be treated is passed through a demineralization chamber of the electrodeionization device to obtain treated water and water is passed through at least one of a concentration chamber and an electrode chamber of the electrodeionization device while the electrodeionization device is energized with a first current, and a water intake mode in which the water to be treated is passed through the demineralization chamber of the electrodeionization device to obtain the treated water in an energized state in which the electrodeionization device is energized with a second current lower than the first current or in an unenergized state in which the electrodeionization device is not energized, wherein the control device operates at least one first electrodeionization device among the plurality of electrodeionization devices alternately in the water intake mode and the water intake and regeneration mode; and
a confluence section that combines the treated water from the plurality of electrodeionization devices,
wherein the control device operates a second electrodeionization device that is different from the first electrodeionization device in the water intake and regeneration mode.

15. The deionized water production system according to claim 11, wherein the power supply device is shared by a plurality of the electrodeionization devices.
